(19) United States
(12) Patent Application Publication
(10) Pub. No.: US 2026/0341936 A1
(43) Pub. Date: Oct. 29, 2026

(54) Secondary Battery

(71) Applicant: LG Energy Solution, Ltd., Seoul (KR)

(72) Inventors: Hyun Hee Lee, Daejeon (KR); Sang Joon Park, Daejeon (KR); Young Jong Son, Daejeon (KR); Seung Hyun Noh, Daejeon (KR); Hyun Jung Suh, Daejeon (KR)

(73) Assignee: LG Energy Solution, Ltd., Seoul (KR)

(21) Appl. No.: 19/657,323

(22) Filed: Apr. 24, 2026

(30) Foreign Application Priority Data
Apr. 24, 2025 (KR) 10-2025-0053665
Dec. 9, 2025 (KR) 10-2025-0194290
Apr. 22, 2026 (KR) 10-2026-0073216

(51) Int. Cl. H01M 50/627; H01M 50/133; H01M 50/15; H01M 50/342; H01M 50/586

(52) U.S. Cl. CPC H01M 50/627; H01M 50/133; H01M 50/15; H01M 50/3425; H01M 50/586

(57) ABSTRACT

A secondary battery into which an electrolyte may be easily injected is provided. The secondary battery includes an electrode assembly; a casing into which the electrode assembly is inserted; a cap plate coupled to the casing and including an electrolyte injection port; and an insulating element disposed between the cap plate and the electrode assembly. The insulating element includes an injection guide facing the electrolyte injection port, and the injection guide includes a concave portion and an extension flow channel.

### CROSS-REFERENCE TO RELATED APPLICATION

This application claims the benefit of foreign priority to Korean Patent Application No. 10-2025-0053665, filed on Apr. 24, 2025, and No. 10-2025-0194290, filed on Dec. 9, 2025, and No. 10-2026-0073216, filed on Apr. 22, 2026, the disclosures of which are incorporated by reference herein in their entirety.

### BACKGROUND

### 1. Technical Field

The present disclosure relates to a secondary battery capable of charging and discharging, and more particularly, to a secondary battery into which an electrolyte may be easily injected.

### 2. Related Art

In recent years, demand for portable electronic devices such as a laptop, a video camera, and a mobile phone has rapidly increased, and the development of an electric vehicle, energy storage battery, robot, and satellite, or the like has been accelerated. Accordingly, research into a high-performance secondary battery capable of repeated charging and discharging has been actively conducted.

Secondary batteries that have currently been commercialized include a nickel-cadmium battery, nickel-metal hydride battery, nickel-zinc battery, and lithium secondary battery. Among these batteries, the lithium secondary battery has attracted significant attention because, compared to a nickel-based battery, the lithium secondary battery exhibits little memory effect, and thus allows easy charging and discharging and has a very low self-discharge rate and high energy density.

The lithium secondary battery generally uses a lithium-based oxide as a positive electrode active material and a carbon-based material as a negative electrode active material. In addition, the lithium secondary battery is provided with: a positive electrode plate and a negative electrode plate, coated with a positive electrode active material and a negative electrode active material, respectively; an electrode assembly in which the positive and negative electrode plates are disposed with a separator interposed therebetween; and an outer casing configured to seal and accommodate the electrode assembly and an electrolyte.

In addition, depending on a shape of a battery casing, the lithium secondary battery may be classified into a can-type secondary battery, in which an electrode assembly is housed in a metal can, and a pouch-type secondary battery, in which an electrode assembly is housed in a pouch made of an aluminum laminate sheet. In addition, depending on a shape of a metal can, the can-type secondary battery may be further classified into a cylindrical battery and a prismatic battery.

The prismatic battery is provided with an electrolyte injection port. If the electrolyte injection port is blocked by foreign matter or an internal component, an electrolyte injection speed may decrease, or the electrolyte may flow backward.

### SUMMARY

The present disclosure provides a secondary battery into which an electrolyte may be easily injected.

According to an aspect of the present disclosure, a secondary battery may include: an electrode assembly including a positive electrode and a negative electrode; a casing a casing accommodating the electrode assembly; a cap plate coupled to the casing and including an electrolyte injection port; and an insulating element disposed between the cap plate and the electrode assembly, wherein the insulating element may include a base plate and an injection guide facing the electrolyte injection port, and the injection guide may include: a concave portion formed to be recessed in the insulating element and surrounded by the base plate and configured to accommodate an electrolyte, wherein the concave portion may include a bottom plate, a side surface configured to connect the bottom plate to the base plate, and at least one side hole passing through the side surface; and an extension flow channel connected to the concave portion via the at least one hole, and configured to extend outward from the concave portion and define a space. The space may be configured to receive electrolyte during an electrolyte injection. The a extension flow channel may extend along the base plate and is recessed into an inner surface of the base plate in a thickness direction of the base plate without extending through an outer surface of the base plate, where the inner surface of the base plate faces the electrode assembly and the outer surface of the base plate faces toward the cap plate.

According to an aspect of the present disclosure, the side hole may include a first portion configured to pass through the side surface in a thickness direction of the side surface and a second portion recessed in a thickness direction of the base plate.

According to an aspect of the present disclosure, an internal cross-sectional area of the concave portion may gradually decrease toward the electrode assembly.

According to an aspect of the present disclosure, the side surface may be formed to be inclined with respect to a lower surface of the cap plate, and an inclination angle between a portion of the side surface that is oriented toward an inner side of the concave portion and a portion of the lower surface of the cap plate that faces the concave portion may be 25 to 75 degrees.

According to an aspect of the present disclosure, a greatest width of the side surface may be 1.25 to 5 times a thickness of a portion of the insulating element that is connected to a longitudinal outer side of the extension flow channel.

According to an aspect of the present disclosure, a greatest width of the side surface may be 1.02 mm to 3.5 mm.

According to an aspect of the present disclosure, the bottom plate may include: a first bottom surface parallel to a lower surface of the cap plate; and a second bottom surface positioned radially outward of the first bottom surface and formed to be inclined downward with respect to the lower surface of the cap plate.

According to an aspect of the present disclosure, the bottom plate may include a portion having a thickness gradually decreasing toward a radial outer side or a portion having a uniform thickness toward a radially outer side.

According to an aspect of the present disclosure, a lower protrusion disposed on the cap plate may be received within the concave portion, and an accommodation space may be formed between the bottom plate and the lower protrusion, where the accommodation space may receive electrolyte during an electrolyte injection.

According to an aspect of the present disclosure, a smallest height of the accommodation space may be 0.25 to 4 times a thickness of the lower protrusion.

According to an aspect of the present disclosure, a height of the accommodation space may be uniform or may gradually increase in a radially outward direction.

According to an aspect of the present disclosure, a distribution space in an annular shape may extend between the lower protrusion and the concave portion, and connect the accommodation space and the side hole.

According to an aspect of the present disclosure, the injection guide may further include an internal hole formed in the bottom plate.

According to an aspect of the present disclosure, a bottom space between an outer end of the internal hole and an outer end of the bottom plate may be formed to be greater than a diameter of the internal hole.

According to an aspect of the present disclosure, a bottom space between an outer end of the internal hole and an outer end of the bottom plate may be 1.05 to 1.8 times a diameter of the internal hole.

According to an aspect of the present disclosure, a bottom space between an outer end of the internal hole and an outer end of the bottom plate may be 1.2 to 3.5 times a diameter of the internal hole.

According to an aspect of the present disclosure, the bottom space may be 3.5 mm to 12.5 mm.

According to an aspect of the present disclosure, the bottom space may be 8.5 mm to 16.5 mm.

According to an aspect of the present disclosure, a bottom channel, connected to the side hole and recessed inward from a side end of the bottom plate, may be formed in the concave portion.

According to an aspect of the present disclosure a bottom groove, connected to the side hole and recessed inward from a side end of the bottom plate, may be formed in the concave portion.

According to an aspect of the present disclosure, the extension flow channel may be formed as a groove recessed from an inner surface of the base plate that faces the electrode assembly.

According to an aspect of the present disclosure, the baste plate may include a plurality of the extension flow channels, and the extension flow channels may extend radially from a center of the concave portion.

According to an aspect of the present disclosure, a length of the extension flow channel may be 0.15 to 0.6 times a smallest diameter of the concave portion.

According to an aspect of the present disclosure, a length of the extension flow channel may be 0.15 to 0.45 times a smallest diameter of the concave portion.

According to an aspect of the present disclosure, the injection guide may further include an internal hole formed in the bottom of the bottom plate. A length of the extension flow channel may be 0.8 to 1.2 times a diameter of the internal hole.

According to an aspect of the present disclosure, a length of the extension flow channel may be 0.4 to 1.5 times a diameter of the internal hole.

According to an aspect of the present disclosure, a length of the extension flow channel may be 0.7 to 1.6 times a width of the extension flow channel in a direction perpendicular to the direction extending outward from the concave portion.

According to an aspect of the present disclosure, a length of the extension flow channel may be 1.5 mm to 6 mm, and a width of the extension flow channel may be 2.5 mm to 6.5 mm.

According to an aspect of the present disclosure, the length of the extension flow channel may be 2 mm to 6 mm, and a width of the extension flow channel may be 2.5 to 6.5 mm.

According to an aspect of the present disclosure, a depth of the extension flow channel may be 0.15 to 0.5 times a thickness of a portion, connected to a longitudinal outer side of the extension flow channel, of the base plate.

According to an aspect of the present disclosure, a depth of the extension flow channel may be 0.02 to 0.35 times a length of the extension flow channel.

According to an aspect of the present disclosure, a depth of the extension flow channel may be 0.1 mm to 0.5 mm.

According to an aspect of the present disclosure, a smallest diameter of the concave portion may be 1.5 to 6.5 times a diameter of the electrolyte injection port.

According to an aspect of the present disclosure, a smallest diameter of the concave portion may be 1.5 to 6 times a diameter of the electrolyte injection port.

According to an aspect of the present disclosure, a smallest diameter of the concave portion may be 9 mm to 16.5 mm.

According to an aspect of the present disclosure, a smallest diameter of the concave portion may be 7 mm to 16.5 mm.

According to an aspect of the present disclosure, a depth of the concave portion may be 0.4 to 2.1 times a thickness of the base plate.

According to an aspect of the present disclosure, a depth of the concave portion may be 1.02 to 2.1 times a thickness of the base plate.

According to an aspect of the present disclosure, a greatest depth of the concave portion may be 0.5 mm to 2.4 mm.

According to an aspect of the present disclosure, the extension flow channel may be formed on an outer surface of the base plate that faces the cap plate, and the injection guide may be connected to the extension flow channel and the base plate may further include a connection hole opened toward the electrode assembly.

According to an aspect of the present disclosure, base plate may further include an extension protrusion configured to protrude from a longitudinal outer side of the extension flow channel toward the electrode assembly.

According to an aspect of the present disclosure, a guide protrusion portion configured to protrude toward the electrode assembly may be formed on an opposite surface of the concave portion, and a spacing protrusion may be formed on a lower portion of the guide protrusion portion and disposed adjacent to a lower end of the internal hole.

According to an aspect of the present disclosure, a guide protrusion portion configured to protrude toward the electrode assembly may be formed on an opposite surface of the concave portion, and the extension flow channel may be connected to an upper end of the guide protrusion portion where the guide protrusion portion and a lower surface of the base plate meet, and may extend outward from the guide protrusion portion.

According to an aspect of the present disclosure, the insulating element may further include a buffer protrusion configured to protrude toward the electrode assembly and support the electrode assembly.

According to an aspect of the present disclosure, the insulating element may include an outer groove formed on an outer side of a portion formed with the buffer protrusion.

According to an aspect of the present disclosure, the buffer protrusion may include a flexible corrugated hollow section.

According to an aspect of the present disclosure, an electrode support portion configured to protrude toward the electrode assembly may be formed at an inner end portion of the buffer protrusion, and a buffer space configured to absorb impact may be formed between the electrode support portion and the buffer protrusion.

According to an aspect of the present disclosure, the extension flow channel may be one among a plurality of extension flow channels that include a first extension flow channel and a second extension flow channel formed on different surfaces of the base plate.

According to an aspect of the present disclosure, the first extension flow channel and the second extension flow channel may be formed on surfaces of the base plate that face opposite directions.

According to an aspect of the present disclosure, the first extension flow channel may be formed on the inner surface of the insulating element that faces the electrode assembly, and the second extension flow channel may be formed on the outer surface of the insulating element that faces the cap plate.

According to an aspect of the present disclosure, the insulating element may further include an exhaust portion positioned below a vent hole formed in the cap plate and having a discharge opening, and the second extension flow channel may connect the concave portion to the discharge opening.

According to an aspect of the present disclosure, the second extension flow channel may include a first extension portion having a width that increases as a distance from the concave portion increases, and a second extension portion having a uniform width and connecting the first extension portion and the exhaust portion.

According to an aspect of the present disclosure, the bottom plate may include a plurality of first portions parallel to the inner surface and a plurality of second portions inclined with respect to the inner surface, wherein the first portions and the second portions may be alternately arranged.

According to an aspect of the present disclosure, a thickness of the second portion may gradually decrease toward a radial outer side of the concave portion.

According to an aspect of the present disclosure, the extension flow channel may be one among a plurality of extension flow channels that includes a first extension flow channel formed on the inner surface of the base plate that faces the electrode assembly and a second extension flow channel formed on the outer surface of the base plate that faces toward the cap plate, and the second extension flow channel may be connected to the second portion.

### BRIEF DESCRIPTION OF THE DRAWINGS

FIG. 1 is a perspective view illustrating a secondary battery according to a first aspect of the present disclosure.

FIG. 2 is an exploded perspective view illustrating some components of the secondary battery in FIG. 1.

FIG. 3 is a cross-sectional view taken along line III-III in FIG. 1.

FIG. 4 is a perspective view illustrating an insulating element of the secondary battery according to the first aspect of the present disclosure, when viewed from above.

FIG. 5 is a perspective view illustrating the insulating element of the secondary battery according to the first aspect of the present disclosure, when viewed from below.

FIG. 6 is a cutaway perspective view illustrating an injection guide of the insulating element according to the first aspect of the present disclosure.

FIG. 7 is a perspective view illustrating the injection guide of the insulating element according to the first aspect of the present disclosure, when viewed from below.

FIG. 8 is a partial cross-sectional view illustrating a cap plate and the insulating element according to the first aspect of the present disclosure.

FIG. 9 is a cross-sectional view illustrating a portion of a concave portion according to the first aspect of the present disclosure.

FIG. 10 is a cross-sectional view of the concave portion according to the first aspect of the present disclosure, taken along a thickness direction, when viewed from an inner side toward an outer side.

FIG. 11 is a cross-sectional view illustrating an exhaust portion of the insulating element according to the first aspect of the present disclosure.

FIG. 12 is a partial cross-sectional view illustrating a cap plate and an insulating element according to a second aspect of the present disclosure.

FIG. 13 is a cutaway perspective view illustrating an injection guide according to a third aspect of the present disclosure.

FIG. 14 is a cross-sectional view illustrating the injection guide according to the third aspect of the present disclosure.

FIG. 15 is a cutaway perspective view illustrating an injection guide according to a fourth aspect of the present disclosure.

FIG. 16 is a cross-sectional view illustrating the injection guide according to the fourth aspect of the present disclosure.

FIG. 17 is a cross-sectional view illustrating an injection guide according to a fifth aspect of the present disclosure.

FIG. 18 is a cutaway perspective view illustrating an injection guide according to a sixth aspect of the present disclosure.

FIG. 19 is a cross-sectional view illustrating the injection guide according to the sixth aspect of the present disclosure.

FIG. 20 is a cutaway perspective view illustrating an injection guide according to a seventh aspect of the present disclosure.

FIG. 21 is a cross-sectional view illustrating the injection guide according to the seventh aspect of the present disclosure.

FIG. 22 is a cross-sectional view illustrating a buffer protrusion of an insulating element according to an eighth aspect of the present disclosure.

FIG. 23 is a cross-sectional view illustrating a buffer protrusion of an insulating element according to a ninth aspect of the present disclosure.

FIG. 24 is a perspective view illustrating a secondary battery according to a tenth aspect of the present disclosure.

FIG. 25 is a cross-sectional view illustrating the secondary battery according to the tenth aspect of the present disclosure.

FIG. 26 is a perspective view illustrating an insulating element of the secondary battery according to the eleventh embodiment of the present disclosure, when viewed from above.

FIG. 27 is a bottom view illustrating an insulating element of the secondary battery according to the eleventh embodiment of the present disclosure.

FIG. 28 is a cutaway perspective view illustrating an injection guide of the insulating element according to the eleventh embodiment of the present disclosure.

FIG. 29 is a partial cross-sectional view illustrating a cap plate and the insulating element according to the eleventh embodiment of the present disclosure.

### DETAILED DESCRIPTION

The present disclosure is subject to various modifications and may have many different aspects, and thus certain aspects will be illustrated by way of example and described in detail in the Detailed Description. It should be understood, however, that this is not intended to limit the present disclosure to certain forms of aspects, but the aspects include all modifications, equivalents, and substitutes that fall within the spirit and scope of the present disclosure.

The terminology used in the present disclosure is used merely for the purpose of describing certain aspects, and is not intended to limit the aspects. The singular form includes the plural form, unless the context clearly dictates otherwise. In the present disclosure, the terms such as “comprising/including” or “having” are intended to specify the presence of a feature, a number, a step, an operation, a component, a part, or a combination thereof described herein, but are not to be construed as precluding the possibility of the presence or addition of one or more other features, numbers, steps, operations, components, parts, or combinations thereof.

Exemplary aspects will be described below in detail with reference to the accompanying drawings. It should be noted that like reference numerals refer to like parts throughout various drawings and exemplary aspects. In certain aspects, a detailed description of functions and configurations well known in the art may be omitted to avoid obscuring appreciation of the disclosure by those skilled in the art. For the same reason, some components may be exaggerated, omitted, or schematically illustrated in the accompanying drawings.

A secondary battery according to a first aspect of the present disclosure will be described below.

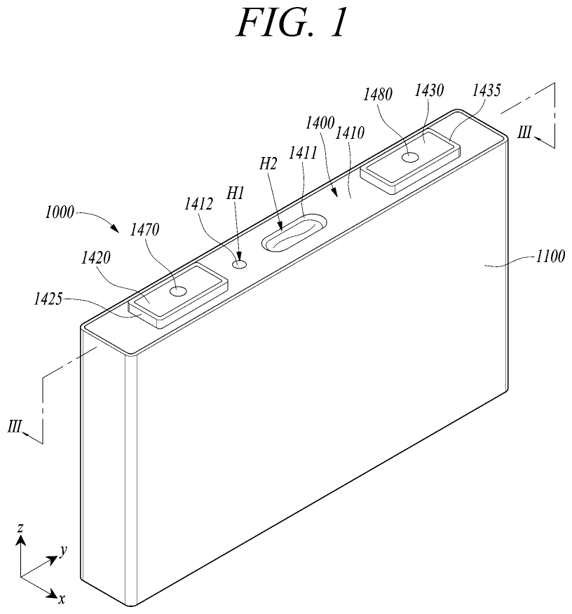

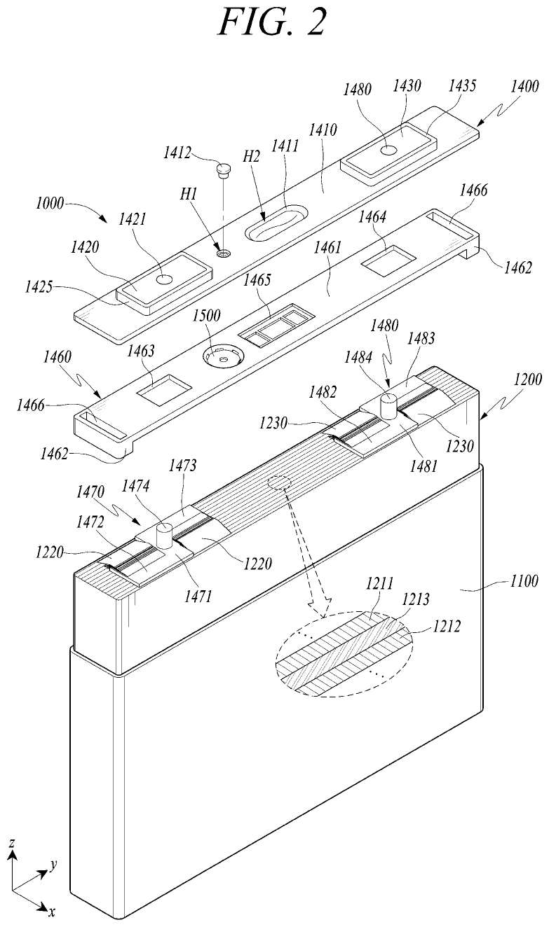

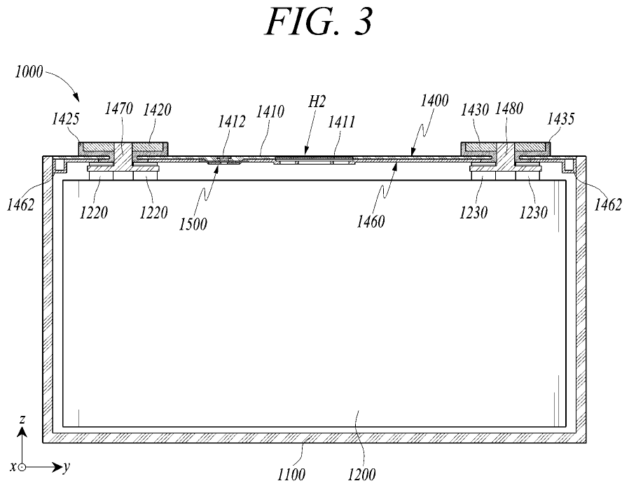

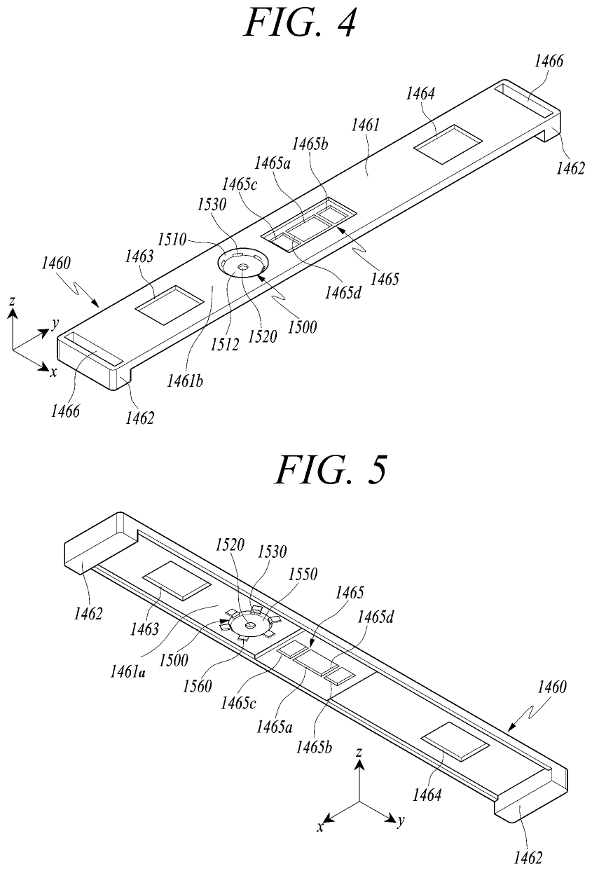

FIG. 1 is a perspective view illustrating a secondary battery according to the first aspect of the present disclosure. FIG. 2 is an exploded perspective view illustrating some components of the secondary battery in FIG. 1. FIG. 3 is a cross-sectional view taken along line III-III in FIG. 1. FIG. 4 is a perspective view illustrating an insulating element of the secondary battery according to the first aspect of the present disclosure, when viewed from above.

Referring to FIG. 1 to FIG. 4, a secondary battery 1000 according to the first aspect may be a lithium-ion secondary battery, and may be configured as a prismatic battery having a casing. However, the present disclosure is not limited thereto, and the secondary battery 1000 may be configured as various types of batteries capable of charging and discharging, such as an a sodium battery, a sodium-ion battery, or a lithium-sulfur battery.

The secondary battery 1000 may include an electrode assembly 1200 including a positive electrode 1211 and a negative electrode 1212, a casing 1100 configured to accommodate the electrode assembly 1200, and a cap assembly 1400 coupled to the casing 1100.

The electrode assembly 1200 includes the positive electrode 1211, the negative electrode 1212, and a separator 1213 interposed between the positive electrode 1211 and the negative electrode 1212. The positive electrode 1211, the separator 1213, and the negative electrode 1212 may be configured in a stacked structure, or configured in a structure wound in a jelly-roll form. In addition, the electrode assembly 1200 may be configured in a structure in which the positive electrode 1211 and the negative electrode 1212 are alternately inserted between the separator 1213 bent in a zigzag shape. In addition, the electrode assembly 1200 may be configured in various forms, such as an anodeless type.

The positive electrode 1211 and the negative electrode 1212 may include a coating portion, which is a region where an active material is applied on a metal foil, and a positive electrode tab 1220 or a negative electrode tab 1230, which is a region where an active material is not applied.

The positive electrode tab 1220 may protrude from an upper end of the positive electrode 1211 toward a cap plate 1410, and the negative electrode tab 1230 may protrude from an upper end of the negative electrode 1212 toward the cap plate 1410. However, the present disclosure is not limited thereto, and the positive electrode tab 1220 and the negative electrode tab 1230 may protrude in directions opposite to each other.

The separator 1213 is disposed between the positive electrode 1211 and the negative electrode 1212, and the separator 1213 prevents a short circuit and enables movement of ions.

The positive electrode tab 1220 and the negative electrode tab 1230 may be spaced apart from each other in a longitudinal direction (y-axis direction) of the cap plate 1410. The positive electrode tabs 1220 and the negative electrode tabs 1230 may be stacked in a thickness direction (x-axis direction) of the casing 1100.

The electrode assembly 1200 may include one or more positive electrode tab arrays having the same polarity, and one or more positive electrode tabs 1220 may be formed on a single positive electrode plate. In addition, the electrode assembly 1200 may include one or more negative electrode tab arrays having the same polarity, and two negative electrode tabs 1230 may be formed on a single negative electrode plate.

In addition, the one or more positive electrode tabs 1220 may be connected to a first terminal 1420 by means of a first current collecting element 1470, and the one or more negative electrode tabs 1230 may be connected to the second terminal 1430 by means of a second current collecting element 1480.

The casing 1100 may be formed in a box shape having an internal space configured to accommodate the electrode assembly 1200. The casing 1100 may be formed in a prismatic shape with a rectangular cross-section; however, the present disclosure is not limited thereto, and the casing 1100 may be formed in various shapes, such as a cylindrical shape. A single electrode assembly 1200 or a plurality of the electrode assemblies 1200 may be inserted into the casing 1100.

The electrode assembly 1200 and an electrolyte may be accommodated inside the casing 1100. The electrolyte may be in a liquid or gel state.

The cap assembly 1400 may include the cap plate 1410 coupled to the casing 1100, the terminals 1420 and 1430 installed on the cap plate 1410, the current collecting elements 1470 and 1480 configured to connect the terminals 1420 and 1430 to the electrode assembly 1200, and an insulating element 1460 disposed between the cap plate 1410 and the electrode assembly 1200.

The cap plate 1410 may be formed of a plate that covers an opening of the casing 1100, and may have a shape corresponding to a shape of the opening of the casing 1100. the cap plate 1410 may be fixed to the casing 1100 by laser welding or adhesive.

The cap plate 1410 may be formed with an electrolyte injection port H1 for injecting an electrolyte and a vent hole H2 in which a vent element 1411 is installed. A sealing plug 1412 configured to block the electrolyte injection port H1 may be installed in the electrolyte injection port H1, and the vent hole H2 may be formed with the vent element 1411 configured to open at a preset pressure.

The terminals 1420 and 1430 may be connected to an outer surface of the cap plate 1410, and one terminal 1420 or 1430 or two terminals 1420 and 1430 may be installed on the cap plate 1410. If two terminals 1420 and 1430 are installed on the cap plate 1410, the first terminal 1420 may be configured as a positive terminal, and the second terminal 1430 may be configured as a negative terminal. In another example, if only one terminal is installed on the cap plate 1410, the casing 1100 may be negatively charged.

The first terminal 1420 and the second terminal 1430 may be formed in a plate shape. The first terminal 1420 may be formed with a terminal hole 1421 into which the first current collecting element 1470 is inserted, and the second terminal 1430 may be formed with a terminal hole 1431 into which the second current collecting element 1480 is inserted.

A gasket 1425 for electrical insulation may be installed between the first terminal 1420 and the cap plate 1410, and a gasket 1435 for electrical insulation may also be installed between the second terminal 1430 and the cap plate 1410. In addition, the gaskets 1425 and 1435 may extend downward and also be positioned between the current collecting elements 1470 and 1480 and the cap plate 1410. The gaskets 1425 and 1435 may be configured as a single element, or divided into a plurality of elements.

The first terminal 1420 may be electrically connected to the one or more positive electrode tabs 1220 by means of the first current collecting element 1470, and the second terminal 1430 may be electrically connected to the one or more negative electrode tabs 1230 by means of the second current collecting element 1480.

The first current collecting element 1470 may include a center portion 1471, a first current collecting protrusion 1472 configured to protrude from one side end of the center portion 1471, a second current collecting protrusion 1473 configured to protrude from a remaining side end of the center portion 1471, and a connection post 1474 configured to protrude from the center portion 1471 toward the cap plate 1410. The first current collecting protrusion 1472 and the second current collecting protrusion 1473 may be spaced apart from each other in the longitudinal direction (y-axis direction) and the thickness direction (x-axis direction) of the electrode assembly 1200.

A first positive electrode tab 1220 may be bonded to the first current collecting protrusion 1472 and a second positive electrode tab 1220 may be bonded to the second current collecting protrusion 1473, and the positive electrode tab arrays may be bent in opposite directions from each other and fixed, such as by welding or clamping, to the first current collecting protrusion 1472 or the second current collecting protrusion 1473. The positive electrode tabs 1220 may be bonded to an upper surface of the first current collecting protrusion 1472 or the second current collecting protrusion 1473.

The connection post 1474 may be formed as a cylinder, although other shapes, such as rectangular or plate-shaped, may be used. The connection post 1474 may be integrally formed with the center portion 1471. However, the present disclosure is not limited thereto, and the connection post 1474 may also be fixed, by welding or being riveted, to the center portion 1471.

In addition, the second current collecting element 1480 may include a center portion 1481, a first current collecting protrusion 1482 configured to protrude from one side end of the center portion 1481, a second current collecting protrusion 1483 configured to protrude from a remaining side end of the center portion 1481, and a connection post 1484 configured to protrude from the center portion 1481 toward the cap plate 1410. The first current collecting protrusion 1482 and the second current collecting protrusion 1483 may be spaced apart from each other in the longitudinal direction (y-axis direction) and the thickness direction (x-axis direction) of the electrode assembly 1200.

A first negative electrode tab 1230 may be bonded to the first current collecting protrusion 1482 and a second negative electrode tab 1230 may be bonded to the second current collecting protrusion 1483, and the negative electrode tab arrays may be bent in opposite directions from each other and fixed, such as by welding or clamping, to the first current collecting protrusion 1482 or the second current collecting protrusion 1483. The negative electrode tabs 1230 may be bonded to an upper surface of the first current collecting protrusion 1482 or the second current collecting protrusion 1483.

The connection post 1474 of the first current collecting element 1470 may be bonded, such as by welding, after being inserted into the first terminal 1420, and the connection post 1484 of the second current collecting element 1480 may be bonded, such as by welding, after being inserted into the second terminal 1430.

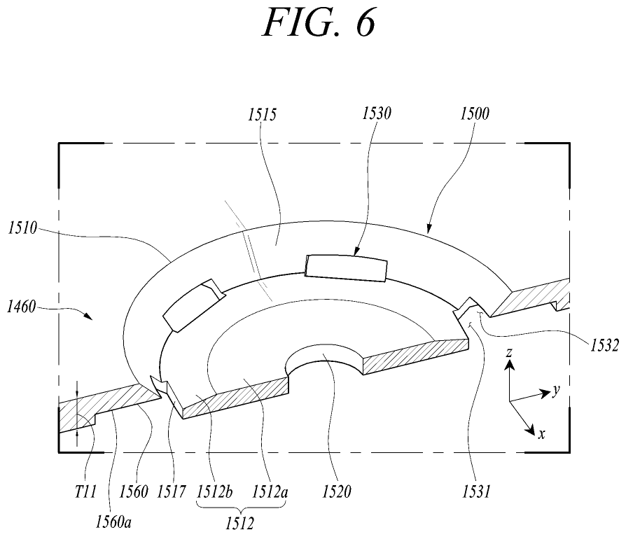

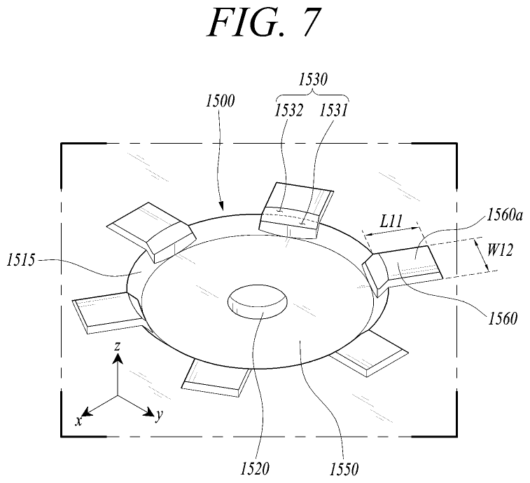

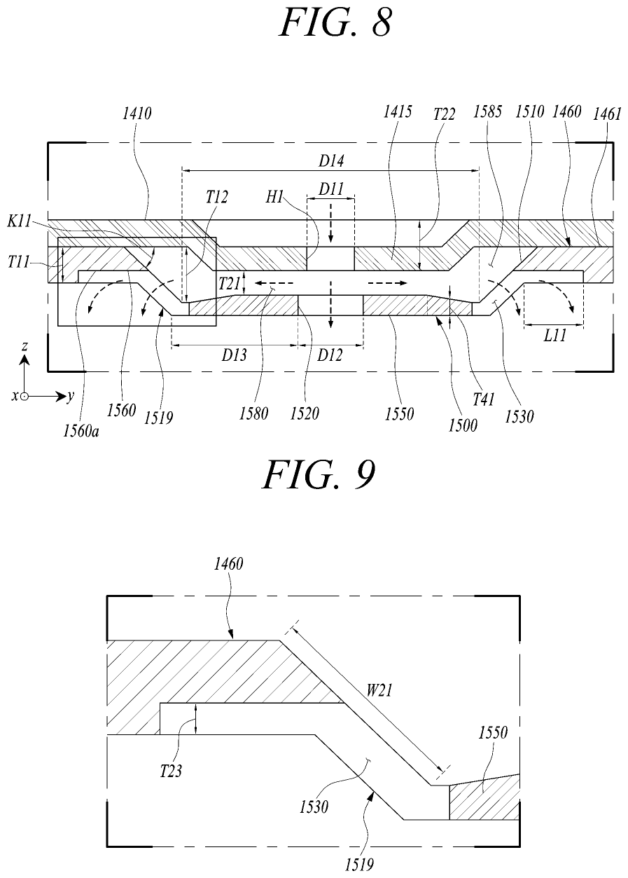

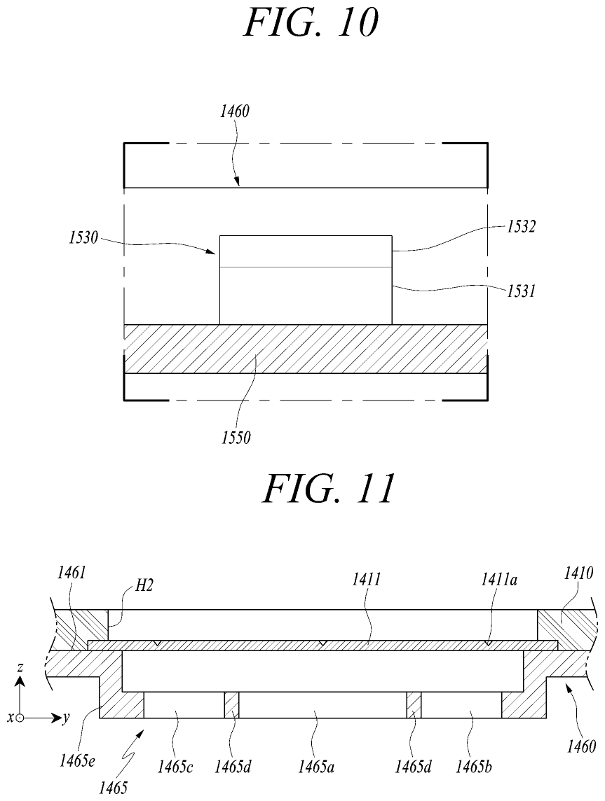

FIG. 4 is a perspective view illustrating an insulating element of the secondary battery according to the first aspect of the present disclosure, when viewed from above. FIG. 5 is a perspective view illustrating the insulating element of the secondary battery according to the first aspect of the present disclosure, when viewed from below. FIG. 6 is a cutaway perspective view illustrating an injection guide of the insulating element according to the first aspect of the present disclosure. FIG. 7 is a perspective view illustrating the injection guide of the insulating element according to the first aspect of the present disclosure, when viewed from below. FIG. 8 is a partial cross-sectional view illustrating a cap plate and the insulating element according to the first aspect of the present disclosure. FIG. 9 is a cross-sectional view illustrating a portion of a concave portion according to the first aspect of the present disclosure. FIG. 10 is a cross-sectional view of the concave portion according to the first aspect of the present disclosure, taken along a thickness direction, when viewed from an inner side toward an outer side.

Referring to FIGS. 4 to 10, the insulating element 1460 is installed between the cap plate 1410 and the electrode assembly 1200, and electrically insulates the cap plate 1410 from the electrode assembly 1200. The insulating element 1460 may have a shape corresponding to the cap plate 1410, and may be formed in a form of an elongated rectangular plate. The insulating element 1460 may be disposed to face the cap plate 1410, and may be disposed parallel to the cap plate 1410.

The insulating element 1460 may include: a base plate 1461 in a form of a rectangular plate; and two buffer protrusions 1462 disposed at opposite ends of the base plate 1461 in the longitudinal direction (y-axis direction) and configured to protrude downward from edges of the opposite ends toward the electrode assembly 1200.

The base plate 1461 may be formed with a first hole 1463 into which a lower end of the gasket 1425 of the first terminal 1420 is inserted, and a second hole 1464 into which a lower end of the gasket 1435 of the second terminal 1430 is inserted.

In response to the electrode assembly 1200 moving in an upward direction (z-axis direction) relative to the base plate 1461, the buffer protrusions 1462 contact the electrode assembly 1200 and may mitigate an impact applied to the electrode assembly 1200. In addition, the buffer protrusions 1462 may be formed to be elastically deformable, and may also contact the electrode assembly 1200 and reduce vibration of the electrode assembly 1200.

One or more outer grooves 1466 may be formed, in the insulating element 1460, on an outer side of a portion (a portion facing upward toward the cap plate 1410) and may located to correspond with the buffer protrusions 1462. With the one or more outer grooves 1466 formed as described above, a thicknesses of the buffer protrusions 1462 may be reduced, and the buffer protrusions 1462 may be easily deformed, such that impact applied to the electrode assembly 1200 may be mitigated.

In addition, the insulating element 1460 may include: an injection guide 1500 positioned below the electrolyte injection port H1; and an exhaust portion 1465 positioned below the vent hole H2.

The injection guide 1500 may be formed in the insulating element 1460 and assists with electrolyte injection. The injection guide 1500 may include a concave portion 1510 that may have an internal hole 1520 and a side hole 1530. The injection guide 1500 may have an extension flow channel 1560 formed in the base plate 1461 of the insulating element 1460.

The concave portion 1510 may be positioned in a lower space corresponding to the electrolyte injection port H1 and may be configured in a structure concavely recessed toward the electrode assembly 1200. The concave portion 1510 may include a bottom plate 1512 positioned at a lower portion and a side surface 1515 configured to connect the bottom plate 1512 to the base plate 1461 of the insulating element 1460. The side surface 1515 may be disposed to be inclined with respect to a lower surface of the cap plate 1410, the bottom plate 1512, and an inner surface 1461a of the base plate 1461 of the insulating element 1460 that may be oriented toward the electrode assembly 1200.

An inclination angle K11 between a portion of the side surface 1515 oriented toward an inner side of the concave portion 1510 and a portion of the lower surface of the cap plate 1410 that faces the concave portion 1510 may be 25 to 75 degrees. If the inclination angle K11 is formed to be less than 25 degrees, an area of the inclined surface increases. Accordingly, strength of the insulating element 1460 decreases, and a height of the concave portion 1510 decreases, resulting in insufficient space for accommodating an electrolyte. In addition, if the inclination angle K11 is formed to be greater than 75 degrees, strength of the insulating element 1460 increases, but an area of the side hole 1530 decreases, making it difficult to rapidly deliver the electrolyte to the extension flow channel 1560 through the side hole 1530.

In addition, a greatest width W21 of the side surface 1515 may be 1.25 to 5 times a thickness T11 of a portion of the insulating element 1460 that is connected to a longitudinal outer side of the extension flow channel 1560. As used herein, the greatest width W21 of the side surface 1515 refers to a length of a longest line segment among line segments that connect upper and lower ends of the side surface 1515 by a shortest distance.

If the greatest width W21 of the side surface 1515 is less than 1.25 times the thickness T11, there is insufficient space for accommodating the electrolyte. Accordingly, the electrolyte may not be uniformly distributed to each of the extension flow channels 1560. If the greatest width W21 of the side surface 1515 is greater than 5 times the thickness T11, a volume of the secondary battery 1000 may unnecessarily increase, and a self-weight of the concave portion 1510 may increase. Accordingly, a longitudinal central portion of the insulating element 1460 may sag downward and be deformed.

The greatest width W21 of the side surface 1515 may be 1.02 mm to 3.5 mm. If the greatest width W21 of the side surface 1515 is less than 1.02 mm, there is insufficient space for accommodating the electrolyte. Accordingly, the electrolyte may not be uniformly distributed to each of the extension flow channels 1560. If the greatest width W21 of the side surface 1515 is greater than 3.5 mm, a volume of the secondary battery 1000 may unnecessarily increase, and a self-weight of the concave portion 1510 may increase. Accordingly, the longitudinal central portion of the insulating element 1460 may sag downward and be deformed.

The concave portion 1510 may be formed to have an inner diameter gradually decreasing toward the electrode assembly 1200. In addition, a guide protrusion portion 1550 configured to protrude convexly inward toward the electrode assembly may be formed on an opposite side of the concave portion 1510.

The bottom plate 1512 may be formed as a substantially circular plate, and may be formed as a flat plate. Accordingly, the concave portion 1510 may have a longitudinal cross-section having a substantially truncated cone shape.

The bottom plate 1512 may include a first bottom surface 1512a parallel to the lower surface of the cap plate 1410 and a second bottom surface 1512b disposed to be inclined with respect to the lower surface of the cap plate 1410. The first bottom surface 1512a may be disposed radially inward of the second bottom surface 1512b, and the second bottom surface 1512b may be disposed to surround the first bottom surface 1512a.

The second bottom surface 1512b may be disposed to be inclined downward with respect to the lower surface of the cap plate 1410. Accordingly, a gap between the first bottom surface 1512a and the cap plate 1410 may be uniformly formed, and a gap between the second bottom surface 1512b and the cap plate 1410 may gradually increase toward the outside. A thickness T41 of the second bottom surface 1512b may be formed to gradually decrease toward a radial outer side.

Accordingly, a height of an accommodation space 1580 gradually increases from the second bottom surface 1512b in a radially outward direction of the second bottom surface 1512b, so an electrolyte supplied to the concave portion 1510 may move rapidly from the first bottom surface 1512a to the second bottom surface 1512b.

A smallest diameter D14 of the concave portion 1510 may be formed to be larger than a diameter D11 of the electrolyte injection port H1, and the smallest diameter D14 of the concave portion 1510 may be 1.5 to 6.5 times the diameter D11 of the electrolyte injection port H1. The smallest diameter D14 of the concave portion 1510 may be 7 mm to 16.5 mm, and the diameter D11 of the electrolyte injection port H1 may be 2 mm to 6 mm. Accordingly, a sufficient amount of electrolyte may be accommodated by the concave portion 1510. Even if a portion of electrolyte injection path is blocked, backflow of the electrolyte may be minimized.

In addition, a greatest depth T12 of the concave portion 1510 may be formed to be greater than a thickness of the insulating element 1460, and the greatest depth T12 of the concave portion 1510 may be formed to be 0.4 to 2.1 times the thickness T11 of the portion of the base plate 1461 of the insulating element 1460 that is connected to the longitudinal outer side of the extension flow channel 1560.

If the greatest depth T12 of the concave portion 1510 is less than 0.4 times the thickness T11, there is insufficient space for accommodating the electrolyte. Accordingly, the electrolyte may not be uniformly distributed to each of the extension flow channels 1560. If the greatest depth T12 of the concave portion 1510 is greater than 2.1 times the thickness T11, a volume of the secondary battery 1000 may unnecessarily increase, and the insulating element 1460 may be deformed.

The greatest depth T12 of the concave portion 1510 may be 0.5 mm to 2.4 mm, and the thickness T11 of the portion of the insulating element 1460 that is connected to the longitudinal outer side of the extension flow channel 1560 may be 0.4 mm to 1.2 mm.

The internal hole 1520 may be positioned at a center of the bottom plate 1512 of the concave portion 1510, and may be formed to face the electrolyte injection port H1. The internal hole may be coaxially aligned with the electrolyte injection port H1. A diameter D12 of the internal hole 1520 may be formed to be larger than the diameter D11 of the electrolyte injection port H1, and the internal hole 1520 may be positioned inside a lower region corresponding to the electrolyte injection port H1.

The diameter D12 of the internal hole 1520 may be 1.05 to 1.5 times the diameter D11 of the electrolyte injection port H1. The diameter D12 of the internal hole 1520 may be 2.5 mm to 6 mm, and the diameter D11 of the electrolyte injection port H1 may be 2 mm to 4 mm. Accordingly, the electrolyte may be preferentially supplied downward through the internal hole 1520. If the supply through the internal hole 1520 is not smooth, the electrolyte may be supplied downward through the side hole 1530 and the extension flow channel 1560 to minimize backflow of the electrolyte.

In addition, a bottom space D13 between an outer end of the internal hole 1520 and an outer end of the bottom plate 1512 of the concave portion 1510 may be formed to be larger than the diameter D12 of the internal hole 1520. The bottom space D13 may be 1.05 to 1.8 times the diameter D12 of the internal hole 1520. Accordingly, if the internal hole 1520 is blocked, the electrolyte may move sufficiently far from the internal hole 1520 and be injected into an open space. The bottom space D13 may be 3.5 mm to 12.5 mm.

The side hole 1530 may be formed in the side surface 1515, and a plurality of the side holes 1530 may be disposed to be spaced apart from each other at intervals in a circumferential direction of the side surface 1515. In addition, the concave portion 1510 may be formed with a bottom channel 1517 connected to the side hole 1530. The bottom channel 1517 is configured in a structure concavely recessed inward in a radial direction from a side end of the bottom plate 1512, and is connected to the side hole 1530 and assists with discharge of the electrolyte from the concave portion 1510.

As illustrated in FIGS. 6, 7 and 10, the side hole 1530 may include a first portion 1531 formed in the side surface 1515 and a second portion 1532 formed to be recessed in a thickness direction of the base plate 1461 of the insulating element 1460. The first portion 1531 may be formed to pass through the side surface 1515, and the second portion 1532 may be recessed in the thickness direction of the base plate 1461 of the insulating element 1460 and connected to the extension flow channel 1560. By including the first portion 1531 and the second portion 1532 of the side hole 1530 as described above, the electrolyte may be easily supplied to the extension flow channel 1560 through the side hole 1530; and even when the side hole 1530 is partially blocked, the electrolyte may be delivered through the second portion 1532.

Since the side hole 1530 is formed in the inclined side surface 1515, as the side hole 1530 extends toward the cap plate 1410, the side hole 1530 gradually extends outward in a radial direction of the concave portion 1510.

In addition, the extension flow channel 1560 may be formed as a groove shape 1560a in the base plate 1461 of the insulating element 1460 and recessed from a surface of the base plate 1461 of the insulating element 1460. However, the present disclosure is not limited thereto. The extension flow channel 1560 may also a channel at least partially embedded within the thickness T11 of the base plate 1461 of the insulating element 1460, such that the channel may be at least partially surrounded by the base plate 1461 of the insulating element 1460.

The base plate 1461 of the insulating element 1460 may include an outer surface oriented toward the cap plate 1410 and an inner surface oriented toward the electrode assembly 1200. The extension flow channel 1560 may be formed on the inner surface of base plate 1461 of the insulating element 1460, and may be connected to the side hole 1530. A convex portion 1519 configured to extend inward toward the electrode assembly may be formed on an opposite side of the concave portion 1510, and the extension flow channel 1560 may extend outward in a radial direction from the convex portion 1519. When viewed from below the insulating element 1460, the extension flow channel 1560 may be substantially connected adjacent to an upper end of the convex portion 1519.

The extension flow channel 1560 may be open downward toward the electrode assembly 1200, and a plurality of the extension flow channels 1560 may be radially disposed. The extension flow channel 1560 may be substantially connected to an upper end of the side hole 1530 and form an additional flow path extending outward from the side hole 1530.

A depth T23 of the extension flow channel 1560 may be 0.15 to 0.5 times the thickness T11 of the portion of base plate 1461 of the insulating element 1460 that is connected to the longitudinal outer side of the extension flow channel 1560. If the depth T23 of the extension flow channel 1560 is less than 0.15 times the thickness T11, an electrolyte injection speed decreases, and a lower structure is easily inserted into the extension flow channel during electrolyte injection. If the depth T23 of the extension flow channel 1560 is greater than 0.5 times the thickness T11, strength of the insulating element 1460 decreases, resulting in deformation of the insulating element 1460 and sagging of the longitudinal central portion of the insulating element 1460.

The depth T23 of the extension flow channel 1560 may be 0.02 to 0.35 times a length L11 of the extension flow channel 1560. If the depth T23 of the extension flow channel 1560 is less than 0.02 times the length L11 of the extension flow channel 1560, an electrolyte injection speed decreases, resulting in reduced productivity. If the depth T23 of the extension flow channel 1560 is greater than 0.35 times the length L11 of the extension flow channel 1560, the insulating element 1460 may be deformed. The depth T23 of the extension flow channel 1560 may be 0.1 mm to 0.5 mm.

The length L11 of the extension flow channel 1560 may be formed smaller than the smallest diameter D14 of the concave portion 1510. As used herein, the length L11 of the extension flow channel 1560 refers to a length of the extension flow channel 1560 measured on a plane of the base plate 1461 of the insulating element 1460 that is oriented toward the electrode assembly 1200.

The length L11 of the extension flow channel 1560 may be 0.15 to 0.6 times the smallest diameter D14 of the concave portion 1510. Accordingly, the electrolyte may be uniformly distributed, thereby improving an electrolyte injection speed, and preventing a decrease in the electrolyte injection speed even when a portion of flow paths is blocked.

In addition, the length L11 of the extension flow channel 1560 may be 0.4 to 1.5 times the diameter D12 of the internal hole 1520. If the length L11 of the extension flow channel 1560 is less than 0.4 times the diameter D12 of the internal hole 1520, an electrolyte injection speed decreases. If the length L11 of the extension flow channel 1560 is greater than 1.5 times the diameter D12 of the internal hole 1520, strength of the insulating element 1460 decreases, resulting in bending of the insulating element 1460.

The length L11 of the extension flow channel 1560 may be 0.7 to 1.6 times a width W12 of the extension flow channel 1560. Accordingly, the length L11 of the extension flow channel 1560 may be sufficiently secured, such that an electrolyte may be rapidly injected through the extension flow channel 1560. The length L11 of the extension flow channel 1560 may be 1.5 mm to 6 mm, and the width W12 of the extension flow channel 1560 may be 2.5 mm to 6.5 mm.

With the extension flow channel 1560 formed in a groove shape 1560a, strength of the insulating element 1460 may be significantly improved, compared to a through-type structure. With the extension flow channel 1560 formed in a hole or cutout shape, strength at a cutout portion may decrease, resulting in sagging, deformation of the insulating element 1460, or damage to the insulating element 1460. In particular, with the secondary battery 1000 installed in a vehicle, vibration may be applied to the secondary battery 1000. Due to the vibration, the central portion of the insulating element 1460 may sag downward, or a crack may occur at the cutout portion or a hole portion. However, according to the present aspect, since the extension flow channel 1560 is formed in a groove shape 1560a, deformation of the insulating element 1460 and occurrence of a crack may be minimized.

In addition, when the extension flow channel 1560 is formed in a groove shape 1560a on the inner surface 1461a of the base plate 1461 of the insulating element 1460, the extension flow channel 1560 may extend for a substantial length while preventing deformation. £ Furthermore, the extension flow channel 1560 may provide a sufficiently large bottom opening area, allowing the electrolyte to easily flow downward.

In addition, the extension flow channel 1560 is connected to an upper end of the guide protrusion portion 15 50 where the guide protrusion portion connects to the inner surface 1461a of the base plate 1461 of the insulating element 1460 and extends outwardly. Even if the lower surface of guide protrusion 1550 contacts an internal element of the electrode assembly 1200, there remains a space between extension flow channel 1560 and the side of protrusion 1550, enabling easy electrolyte injection. That is, according to the present aspect, the guide protrusion portion 1550 may serve to prevent an internal element of the electrode assembly 1200 from moving upward and blocking the extension flow channel 1560.

Where the extension flow channel 1570 is formed as a groove on the outer surface 1461b of the base plate 1461 of the insulating element 1460 or formed as an embedded extension flow channel, a connection hole 1572 connecting the extension flow channel to the inner surface 1461a of the base plate 1461 of the insulating element 1460 may be appropriate. However, such a connection hole 1572 would provide a smaller opening area of the extension flow channel on the inner surface 1461a of the base plate 1461 of the insulating element 1460. Furthermore, if the connection hole 1572 were to become blocked, problems such as a drop in injection speed or backflow may occur. Additionally, the presence of the hole may induce deformation of the insulating element 1460.

In addition, a lower protrusion 1415 may be formed at a lower portion of the cap plate and may be inserted into the concave portion 1510, and the lower protrusion 1415 may be formed in a truncated cone shape having an outer diameter gradually decreasing toward its lower portion. The accommodation space 1580 configured to accommodate an electrolyte may be formed between the lower protrusion 1415 and the bottom plate 1512 of the concave portion 1510. A smallest height T21 of the accommodation space 1580 may be 0.25 to 4 times a thickness T22 of the lower protrusion 1415. The greatest depth T12 of the concave portion 1510 may be 1.1 to 6 times smallest height T21 of the accommodation space 1580. The accommodation space 1580 may be connected to the extension flow channel 1560 and deliver an electrolyte to the extension flow channel 1560. As used herein, the thickness T22 of the lower protrusion 1415 refers to a distance from an upper surface of the cap plate 1410 to a lower end of the lower protrusion 1415.

In addition, an outer surface of the lower protrusion 1415 may be spaced apart from an inner surface of the concave portion 1510, such that a distribution space 1585 in an annular shape, in which an electrolyte may be temporarily accommodated, may be formed between the lower protrusion 1415 and the concave portion 1510. The distribution space 1585 may be formed to have a height greater than a greatest height of the accommodation space 1580.

The distribution space 1585 may be connected to the accommodation space 1580 and the side hole 1530 and distributes the electrolyte. The electrolyte that has moved to the distribution space 1585 may be uniformly distributed and supplied to the extension flow channel 1560 through the side hole 1530. Accordingly, the electrolyte may be uniformly supplied to each of the extension flow channels 1560, enabling rapid injection of the electrolyte.

As in the first aspect, with the injection guide 1500 formed, the electrolyte may be easily injected into the casing 1100. The electrolyte injected through the electrolyte injection port H1 may be accommodated in the concave portion 1510, and move into the casing 1100 through the internal hole 1520. If an inside of the internal hole 1520 is blocked by foreign matter or the like, the electrolyte may move to an outside of the concave portion 1510 through the accommodation space 1580, and then be injected into the casing 1100 through the side hole 1530.

In addition, if the side holes 1530 are blocked by an internal structure, the electrolyte may move outward through the extension flow channel 1560 connected to the side holes 1530 and be injected into the casing 1100. As described above, according to the first aspect, the electrolyte may be easily injected into the casing 1100 through various paths.

In addition, the electrolyte may be injected through an injection nozzle, or may be injected due to a pressure difference created when an inside of the casing 1100 is depressurized to a pressure lower than atmospheric pressure.

If the electrolyte is injected by the pressure difference, a pressure delivery path should be secured. According to the first aspect, the pressure delivery path may be secured through the internal hole 1520, the side hole 1530, and the extension flow channel 1560, such that electrolyte injection time may be reduced.

FIG. 11 is a cross-sectional view illustrating an exhaust portion of the insulating element according to the first aspect of the present disclosure.

Referring to FIG. 11, the exhaust portion 1465 may be positioned below the vent hole H2 and includes a plurality of discharge openings. The exhaust portion 1465 may include: a support frame 1465e configured to protrude downward and formed in an annular shape; and a plurality of divided bars 1465d fixed to the support frame 1465e and configured to extend in the width direction (x-axis direction) of the insulating element 1460. A first discharge opening 1465a may be formed at a center of the exhaust portion 1465, and a second discharge opening 1465b and a third discharge opening 1465c may be formed on opposite sides of the first discharge opening 1465a. The first discharge opening 1465a has a larger cross-sectional area than the second discharge opening 1465b and the third discharge opening 1465c.

As described above, with the exhaust portion 1465 formed in the insulating element 1460, in response to an increase in an internal pressure of the casing 1100, the vent element 1411 may be ruptured at a preset pressure, such that gas inside the casing 1100 may be easily discharged.

A secondary battery according to a second aspect of the present disclosure will be described below.

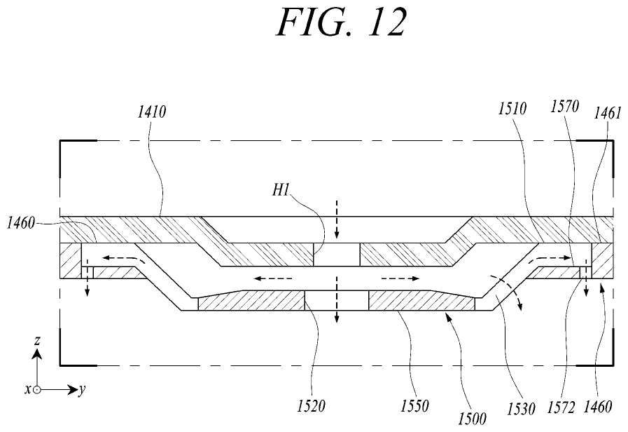

FIG. 12 is a partial cross-sectional view illustrating a cap plate and an insulating element according to the second aspect of the present disclosure.

Referring to FIG. 12, the secondary battery according to the second aspect of the present disclosure has the same structure as the secondary battery according to the first aspect described above except for an extension flow channel 1570. Accordingly, a redundant description of the same component will be omitted.

In addition, the extension flow channel 1570 may be formed in a groove shape recessed from a surface of the base plate 1461 of the insulating element 1460. The base plate 1461 of the insulating element 1460 may include the outer surface oriented toward the cap plate 1410 and the inner surface oriented toward the electrode assembly 1200. The extension flow channel 1570 may be formed on the outer surface 1461b of the base plate 1461 of the insulating element 1460, and may be open upward toward the cap plate 1410.

One side end portion of the extension flow channel 1570 in a longitudinal direction may be connected to the side hole 1530. The base plate 1461 of the insulating element 1460 may be formed with a connection hole 1572 connected to the extension flow channel 1570, and the connection hole 1572 may be open toward the electrode assembly 1200.

The insulating element 1460 may be formed with a plurality of the extension flow channels 1570, and the extension flow channels 1570 may be radially disposed. The extension flow channel 1570 may be substantially connected to the upper end of the side hole 1530 and form an additional flow path extending outward from the side hole 1530. The electrolyte introduced into the extension flow channel 1570 may move toward the electrode assembly 1200 through the connection hole 1572.

A secondary battery according to a third aspect of the present disclosure will be described below.

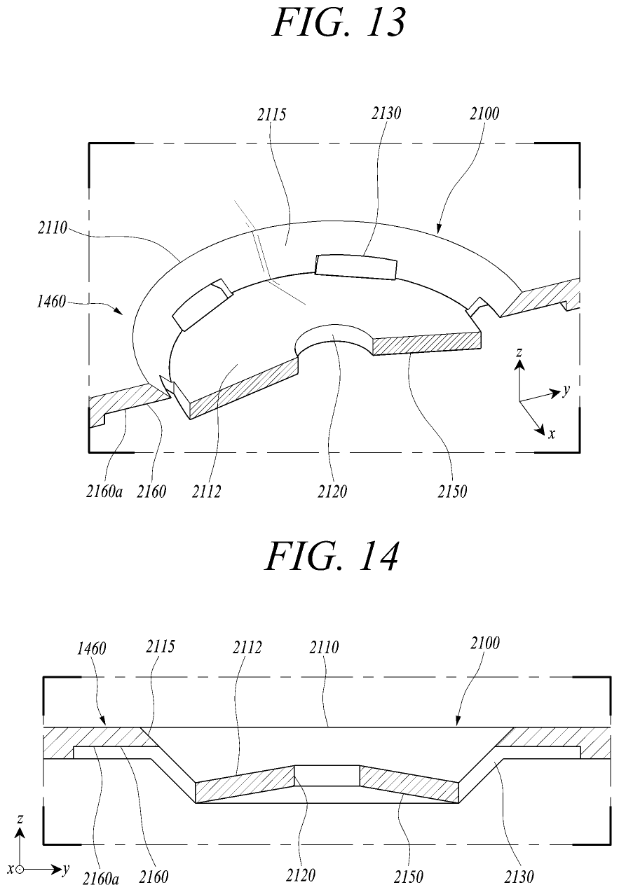

FIG. 13 is a cutaway perspective view illustrating an injection guide according to the third aspect of the present disclosure. FIG. 14 is a cross-sectional view illustrating the injection guide according to the third aspect of the present disclosure.

Referring to FIGS. 13 and 14, the secondary battery according to the third aspect of the present disclosure has the same structure as the secondary battery according to the first aspect described above except for an injection guide 2100. Accordingly, a redundant description of the same component will be omitted.

The insulating element 1460 may be formed with the injection guide 2100, and the injection guide 2100 may include a concave portion 2110 that may have an internal hole 2120 and a side hole 2130, The injection guide 2100 may have an extension flow channel 2160 formed in the base plate 1461 of the insulating element 1460. The concave portion 2110 may be positioned in a lower space corresponding to the electrolyte injection port H1 and may be configured in a structure concavely recessed toward the electrode assembly 1200. The concave portion 2110 includes a bottom plate 2112 positioned at a lower portion and a side: surface 2115 configured to connect the bottom plate 2112 to the base plate 1461 of the insulating element 1460, and the side surface 2115 may be disposed to be inclined with respect to the inner surface 1461a of the base plate 1461 of the insulating element 1460.

The concave portion 2110 may be formed to have an inner diameter gradually decreasing toward the electrode assembly 1200. In addition, a guide protrusion portion 2150 configured to protrude convexly toward the electrode assembly 1200 may be formed on an opposite side of the concave portion 2110.

£ The bottom plate 2112 may be formed in a disc shape, and may be formed to gradually protrude, from an outer side of the bottom plate 2112 toward a center of the same, toward the cap plate 1410. Accordingly, a depth of the concave portion 2110 may gradually increase from a radial center of the concave portion 2110 toward an outer side of the same. The bottom plate 2112 may have a uniform thickness, and may be formed to be inclined with respect to an upper surface of the base plate 1461 of the insulating element 1460.

In addition, the internal hole 2120 may be positioned at a center of the bottom plate 2112 of the concave portion 2110, and may be formed to face the electrolyte injection port H1. The internal hole 2120 may be coaxially aligned with the electrolyte injection port H1. The side hole 2130 may be formed in the side surface 2115, and a plurality of the side holes 2130 may be disposed to be spaced apart from each other at intervals in a circumferential direction of the side surface 2115. The extension flow channel 2160 may be connected to the side hole 2130, and may be formed in a groove shape 2160a recessed from the inner surface 1461a of the base plate 1461 of the insulating element 1460.

According to the third aspect, an electrolyte supplied to the concave portion 2110 may move into the casing 1100 through the internal hole 2120, and an electrolyte that has not moved through the internal hole 2120 may move radially outside a circumference of the inclined bottom plate 2112, and move into the casing 1100 through the side hole 2130. In addition, an electrolyte that has not moved through the side hole 2130 or through the internal hole 2120 may move into the casing 1100 through the extension flow channel 2160.

A secondary battery according to a fourth aspect of the present disclosure will be described below.

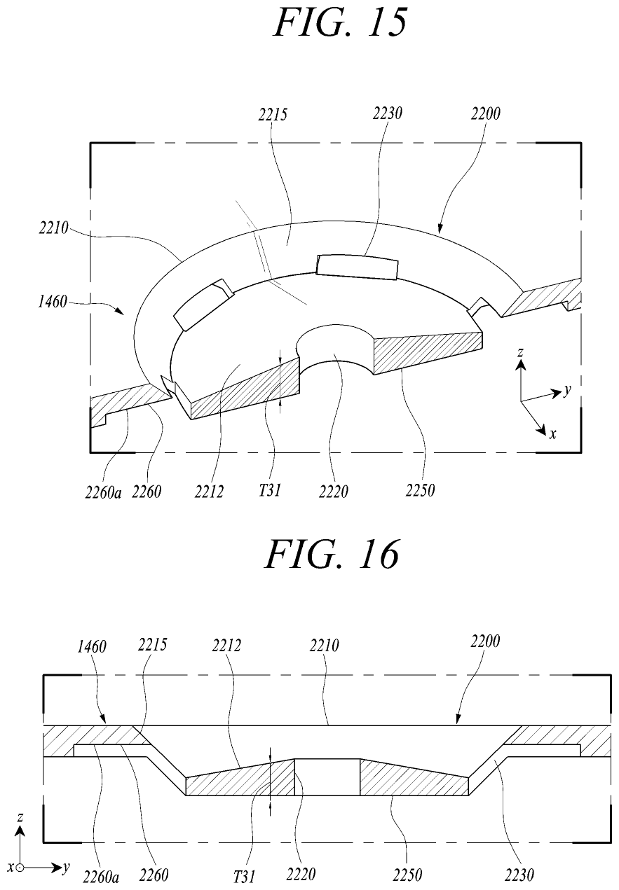

FIG. 15 is a cutaway perspective view illustrating an injection guide according to the fourth aspect of the present disclosure. FIG. 16 is a cross-sectional view illustrating the injection guide according to the fourth aspect of the present disclosure.

Referring to FIGS. 15 and 16, the secondary battery according to the fourth aspect of the present disclosure has the same structure as the secondary battery according to the first aspect described above except for an injection guide 2200. Accordingly, a redundant description of the same component will be omitted.

The insulating element 1460 may be formed with the injection guide 2200, and the injection guide 2200 may include a concave portion 2210 that may have an internal hole 2220, and a side hole 2230. The injection guide 2200 may have an extension flow channel 2260 formed in the base plate 1461 of the insulating element 1460. The concave portion 2210 may be positioned in a lower space corresponding to the electrolyte injection port H1 and may be configured in a structure concavely recessed toward the electrode assembly 1200. The concave portion 2210 includes a bottom plate 2212 positioned at a lower portion and a side surface 2215 configured to connect the bottom plate 2212 to the base plate 1461 of the insulating element 1460, and the side surface 2215 may be disposed to be inclined with respect to the inner surface 1461a of the base plate 1461 of the insulating element 1460.

The concave portion 2210 may be formed to have an inner diameter gradually decreasing toward the electrode assembly 1200. In addition, a guide protrusion portion 2250 configured to protrude convexly toward the electrode assembly 1200 may be formed on an opposite side of the concave portion 2210.

The bottom plate 2212 may be formed in a disc shape, and may be formed to have a thickness T31 gradually decreasing from a radial center toward an outer side of the bottom plate 2212. Accordingly, a depth of the concave portion 2210 may gradually increase from a center toward an outer side of the concave portion 2210.

In addition, the internal hole 2220 may be positioned at a center of the bottom plate 2212 of the concave portion 2210, and may be formed to face the electrolyte injection port H1. The internal hole 2220 may be coaxially aligned with the electrolyte injection port H1. The side hole 2230 may be formed in the side surface 2215, and a plurality of the side holes 2230 may be disposed to be spaced apart from each other at intervals in a circumferential direction of the side surface 2215. The extension flow channel 2260 may be connected to the side hole 2230, and may be formed in a groove shape 2260a recessed from the inner surface 1461a of the base plate 1461 of the insulating element 1460.

According to the fourth aspect, an electrolyte supplied to the concave portion 2210 may move into the casing 1100 through the internal hole 2220, and an electrolyte that has not moved through the internal hole 2220 may move radially outside a circumference of the inclined bottom plate 2212 and move into the casing 1100 through the side hole 2230. In addition, an electrolyte that has not moved through the side hole 2230 may move into the casing 1100 through the extension flow channel 2260.

A secondary battery according to a fifth aspect of the present disclosure will be described below.

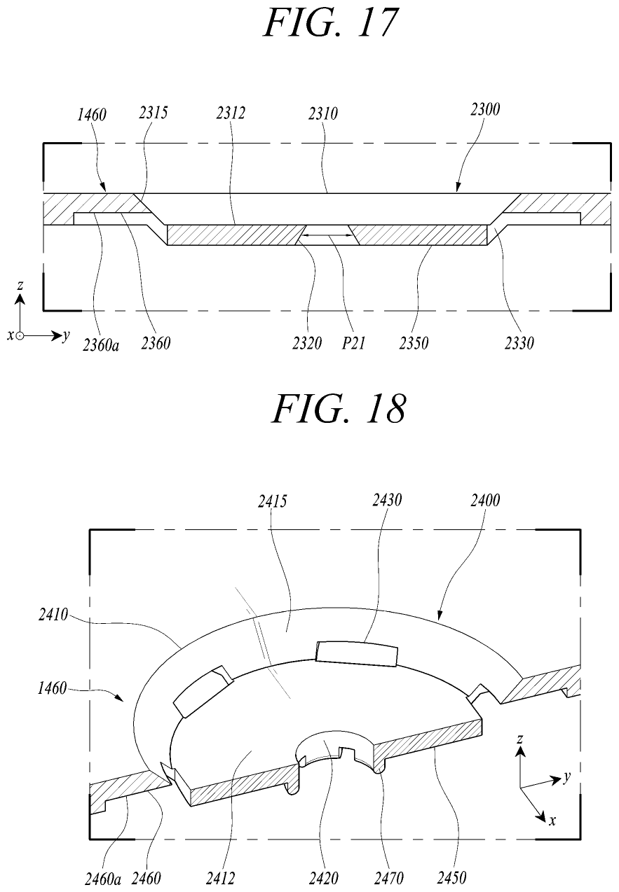

FIG. 17 is a cross-sectional view illustrating an injection guide according to the fifth aspect of the present disclosure.

Referring to FIG. 17, the secondary battery according to the fifth aspect of the present disclosure has the same structure as the secondary battery according to the first aspect described above except for an injection guide 2300. Accordingly, a redundant description of the same component will be omitted.

The insulating element 1460 may be formed with the injection guide 2300, and the injection guide 2300 may include a concave portion 2310 that may have an internal hole 2320, a side hole 2330. The injection guide 2300 may have an extension flow channel 2360 formed in the base plate 1461 of the insulating element 1460.

The concave portion 2310 may be positioned in a lower space corresponding to the electrolyte injection port H1 and may be configured in a structure concavely recessed toward the electrode assembly 1200. The concave portion 2310 may be formed to have an inner diameter gradually decreasing toward the electrode assembly 1200. In addition, a guide protrusion portion 2350 configured to protrude convexly inward may be formed on an opposite side of the concave portion 2310. The concave portion 2310 includes a bottom plate 2312 positioned at a lower portion and a side surface 2315 configured to connect the bottom plate 2312 to the base plate 1461 of the insulating element 1460, and the side surface 2315 may be disposed to be inclined with respect to the inner surface 1461a of the base plate 1461 of the insulating element 1460.

In addition, the internal hole 2320 may be positioned at a center of the bottom plate 2312 of the concave portion 2310, and may be formed to face the electrolyte injection port H1. The internal hole 2320 may be coaxially aligned with the electrolyte injection port H1. The side hole 2330 may be formed in the side surface 2315, and a plurality of the side holes 2330 may be disposed to be spaced apart from each other at intervals in a circumferential direction of the side surface 2315. The extension flow channel 2360 may be connected to the side hole 2330, and may be formed in a groove shape 2360a recessed from the inner surface 1461a of the base plate 1461 of the insulating element 1460.

The internal hole 2320 may be formed to have a diameter D21 gradually increasing toward its lower portion. Accordingly, a movement speed of an electrolyte in the internal hole 2320 may decrease. The decrease in the electrolyte movement speed may prevent deformation of an upper portion of the separator 1213 caused by impact of the electrolyte.

A secondary battery according to a sixth aspect of the present disclosure will be described below.

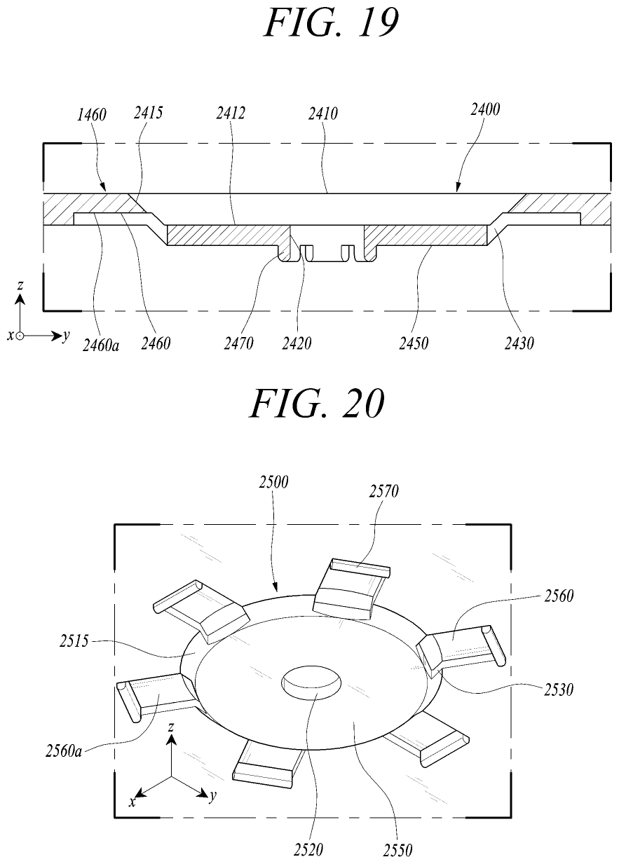

FIG. 18 is a cutaway perspective view illustrating an injection guide according to the sixth aspect of the present disclosure. FIG. 19 is a cross-sectional view illustrating the injection guide according to the sixth aspect of the present disclosure.

Referring to FIGS. 18 and 19, the secondary battery according to the sixth aspect of the present disclosure has the same structure as the secondary battery according to the first aspect described above except for an injection guide 2400. Accordingly, a redundant description of the same component will be omitted.

The insulating element 1460 may be formed with the injection guide 2400, and the injection guide 2400 may include a concave portion 2410 that may have an internal hole 2420 and a side hole 2430 The injection guide 2400 may include extension flow channel 2460 formed in the base plate 1461 of the insulating element 1460.

The concave portion 2410 may be positioned in a lower space corresponding to the electrolyte injection port H1 and maybe configured in a structure concavely recessed toward the electrode assembly 1200. The concave portion 2410 may be formed to have an inner diameter gradually decreasing toward the electrode assembly 1200. In addition, a guide protrusion portion 2450 configured to protrude convexly inward may be formed on an opposite side of the concave portion 2410. The concave portion 2410 includes a bottom plate 2412 positioned at a lower portion and a side surface 2415 configured to connect the bottom plate 2412 to the base plate 1461 of the insulating element 1460, and the side surface 2415 may be disposed to be inclined with respect to the inner surface 1461a of the base plate 1461 of the insulating element 1460.

In addition, the internal hole 2420 may be positioned at a center of the bottom plate 2412 of the concave portion 2410, and may be formed to face the electrolyte injection port H1. The internal hole 2420 may be coaxially aligned with the electrolyte injection port H1. The side hole 2430 may be formed in the side surface 2415, and a plurality of the side holes 2430 may be disposed to be spaced apart from each other at intervals in a circumferential direction of the side surface 2415. The extension flow channel 2460 may be connected to the side hole 2430, and may be formed in a groove shape 2460a recessed from the inner surface 1461a of the base plate 1461 of the insulating element 1460.

A spacing protrusion 2470 may be formed on a lower portion of the guide protrusion portion 2450 and disposed adjacent to a lower end of the internal hole 2420. The spacing protrusion 2470 protrudes toward the electrode assembly 1200 and forms a gap between an internal structure and the lower end of the internal hole 2420. A plurality of the spacing protrusions 2470 may be disposed, on the lower portion of the guide protrusion portion 2450, to be spaced apart from each other in a circumferential direction of the internal hole 2420.

In the sixth aspect, with the spacing protrusion 2470 formed on a lower portion of the of the guide protrusion 2450, the spacing protrusion 2470 may form a gap between the internal structure and the lower end of the internal hole 2420, and an electrolyte may move into the casing 1100 through the gap formed by the spacing protrusion 2470.

A secondary battery according to a seventh aspect of the present disclosure will be described below.

FIG. 20 is a cutaway perspective view illustrating an injection guide according to the seventh aspect of the present disclosure. FIG. 21 is a cross-sectional 1 view illustrating the injection guide according to the seventh aspect of the present disclosure.

Referring to FIGS. 20 and 21, the secondary battery according to the seventh aspect of the present disclosure has the same structure as the secondary battery according to the first aspect described above except for an injection guide 2500. Accordingly, a redundant description of the same component will be omitted.

The insulating element 1460 may be formed with the injection guide 2500, and the injection guide 2500 may include a concave portion 2510 that may have an internal hole 2520, a side hole 2530. The injection guide 2500 may have a extension flow channel 2560 formed in the base plate 1461 of the insulating element 1460.

The concave portion 2510 may be positioned in a lower space corresponding to the electrolyte injection port H1 and may be configured in a structure concavely recessed toward the electrode assembly 1200. The concave portion 2510 may be formed to have an inner diameter gradually decreasing toward the electrode assembly 1200. In addition, a guide protrusion portion 2550 configured to protrude convexly inward may be formed on an opposite side of the concave portion 2510. The concave portion 2510 includes a bottom plate 2512 positioned at a lower portion and a side surface 2515 configured to connect the bottom plate 2512 to the base plate 1461 of the insulating element 1460, and the side surface 2515 may be disposed to be inclined with respect to the inner surface 1461a of the base plate 1461 of the insulating element 1460.

In addition, the internal hole 2520 may be positioned at a center of the bottom plate 2512 of the concave portion 2510, and may be formed to face the electrolyte injection port H1. The internal hole 2520 may be coaxially aligned with the electrolyte injection port. The side hole 2530 may be formed in the side surface 2515, and a plurality of the side holes 2530 may be disposed to be spaced apart from each other at intervals in a 32 circumferential direction of the side surface 2515. The extension flow channel 2560 may be connected to the side hole 2530, and may be formed in a groove shape 2560a recessed from the inner surface 1461a of the base plate 1461 of the insulating element 1460.

The injection guide 2500 may further include an extension protrusion 2570 formed on a longitudinal outer side of the extension flow channel 2560 and configured to protrude toward the electrode assembly 1200. The extension protrusion 2570 protrudes downward from the outer side of the extension flow channel 2560 and forms a gap between an internal structure and a lower end of the extension flow channel 2560.

As in the seventh aspect, with the extension protrusion 2570 formed on a lower portion of the extension flow channel 2560, the extension protrusion 2570 may form a gap between the internal structure and the lower end of the extension flow channel 2560, and an electrolyte may move into the casing 1100 through the gap formed by the extension protrusion 2570.

A secondary battery according to an eighth aspect of the present disclosure will be described below.

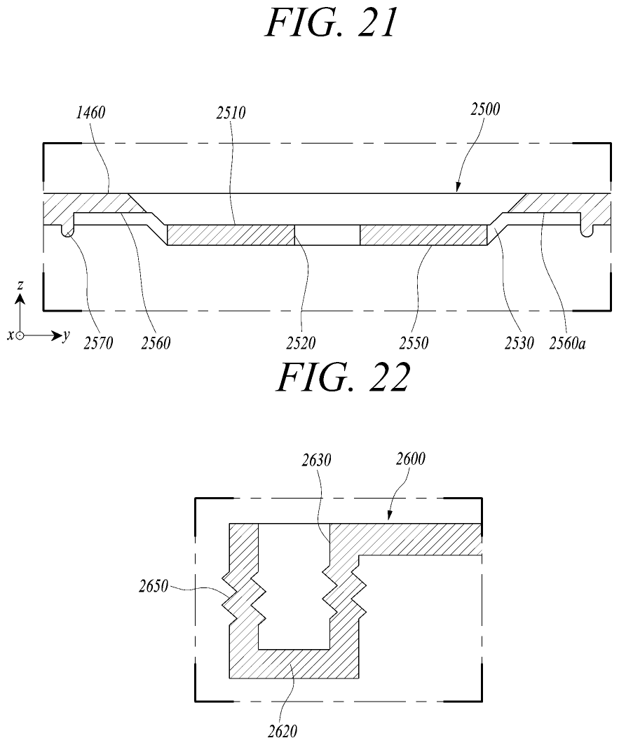

FIG. 22 is a cross-sectional view illustrating a buffer protrusion of an insulating element according to the eighth aspect of the present disclosure.

Referring to FIG. 22, the secondary battery according to the eighth aspect of the present disclosure has the same structure as the secondary battery according to the first aspect described above except for an insulating element 2600. Accordingly, a redundant description of the same component will be omitted.

Two buffer protrusions 2620 configured to protrude downward toward the electrode assembly 1200 may be formed on longitudinal opposite edges of the insulating element 2600. An outer groove 2630 may be formed on an outer side of the buffer protrusion 2620 that is oriented toward the cap plate 1410.

The buffer protrusion 2620 may be formed in a cup shape configured to protrude downward, and the buffer protrusion 2620 may be formed with a corrugated hollow section 2650, such as a tube or pipe. The corrugated hollow section 2650 may be configured in as flexible structure, and may be formed in an accordion, or bellows, shape. In addition, a lower end of the buffer protrusion 2620 may be installed to contact the electrode assembly 1200.

As in the eighth aspect, with the buffer protrusion 2620 formed with the corrugated tube or pipe 2650 and contacting the electrode assembly 1200, in response to impact being applied to the secondary battery or the secondary battery moving abruptly, the buffer protrusion 2620 may stably support the electrode assembly 1200, such that damage to the electrode assembly 1200 may be prevented.

A secondary battery according to a ninth aspect of the present disclosure will be described below.

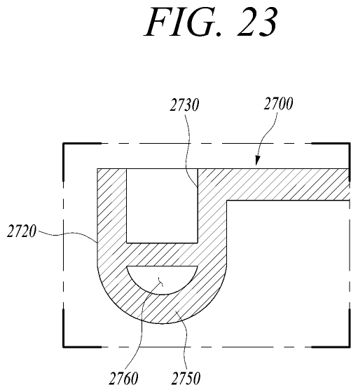

FIG. 23 is a cross-sectional view illustrating a buffer protrusion of an insulating element according to the ninth aspect of the present disclosure.

Referring to FIG. 23, the secondary battery according to the ninth aspect of the present disclosure has the same structure as the secondary battery according to the first aspect described above except for an insulating element 2700. Accordingly, the same description of the same structure will be omitted.

Two buffer protrusions 2720 configured to protrude downward toward the electrode assembly 1200 may be formed on longitudinal opposite edges of the insulating element 2700. An outer groove 2730 may be formed on an outer side of the buffer protrusion 2720 that is oriented toward the cap plate 1410.

The buffer protrusion 2720 may be formed in a cup shape configured to protrude downward, and an electrode support portion 2750 configured to protrude toward the electrode assembly 1200 may be formed at an inner end of the buffer protrusion 2720 that is oriented toward the electrode assembly 1200. The electrode support portion 2750 may be configured in an arcate structure, and may have a substantially semi-circular cross section. A buffer space 2760 configured to absorb impact may be formed between the electrode support portion 2750 and the buffer protrusion 2720. Here, the electrode support portion 2750 may be configured to be easily deformable, and the electrode support portion 2750 may be formed to have a smaller thickness than the buffer protrusion 2720.

In the ninth aspect, with the electrode support portion 2750 and the buffer space 2760 formed, in response to impact being applied to the secondary battery, the electrode support portion 2750 may support the electrode assembly 1200, such that damage to the electrode assembly 1200 may be prevented.

A secondary battery according to a tenth aspect of the present disclosure will be described below.

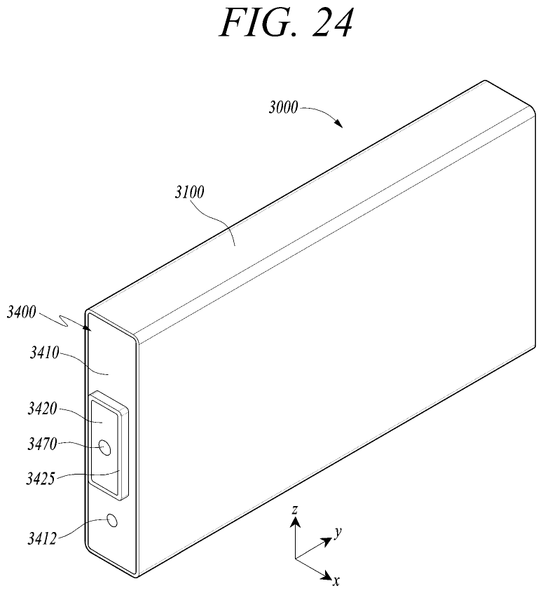

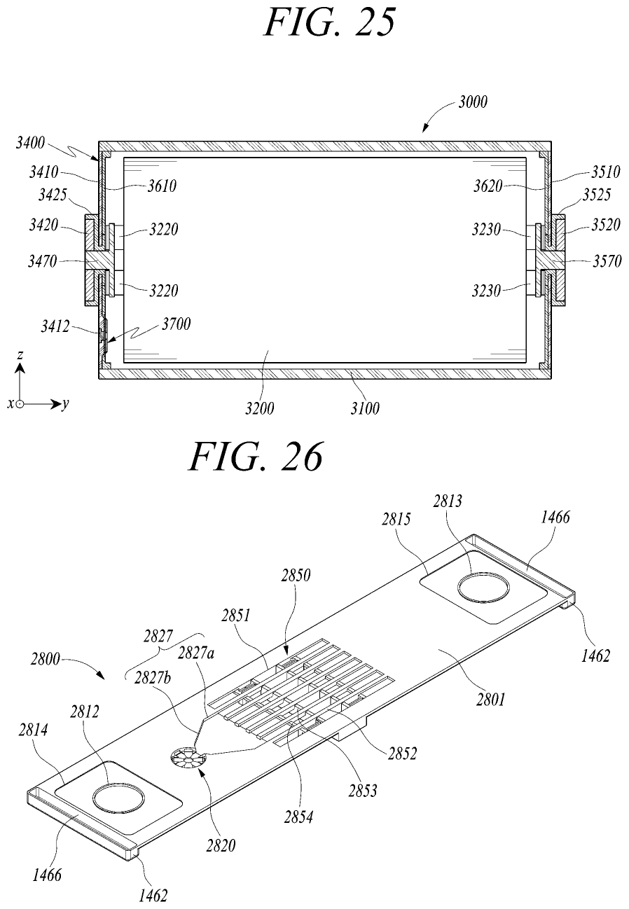

FIG. 24 is a perspective view illustrating a secondary battery according to the tenth aspect of the present disclosure. FIG. 25 is a cross-sectional view illustrating the secondary battery according to the tenth aspect of the present disclosure.

Referring to FIG. 24 and FIG. 25, a secondary battery 3000 according to the tenth aspect has the same or similar structure as the secondary battery according to the first aspect described above except for the configuration of a casing 3100, a first cap assembly 3400, a second cap assembly 3500, and an electrode tab. Accordingly, a redundant description of the same or similar component will be omitted.

The secondary battery 3000 may include an electrode assembly 3200, the casing 3100, the first cap assembly 3400, and the second cap assembly 3500.

The electrode assembly 3200 performs charging and discharging, and includes a positive electrode tab 3220 configured to protrude in a first direction and a negative electrode tab 3230 configured to protrude in a second direction opposite to the first direction. The electrode assembly 3200 may include a plurality of positive electrode tab arrays and two negative electrode tab arrays.

The casing 3100 may have a hollow section with both longitudinal ends open. The first cap assembly 3400 may be coupled to one longitudinal side end portion of the casing 3100, and the second cap assembly 3500 may be coupled to a remaining longitudinal side end portion of the casing 3100.

The first cap assembly 3400 may include a first cap plate 3410 coupled to the casing 3100, a first terminal 3420 installed on the first cap plate 3410, and a first current collecting element 3470 fixed to the first terminal 3420 and coupled to the positive electrode tab 3220. The first terminal 3420 may be formed in a plate shape, and protrudes outward from the first cap plate 3410. A gasket 3425 for insulation may be installed between the first terminal 3420 and the first cap plate 3410. The first current collecting element 3470 may be inserted into the first terminal 3420 and coupled, by welding, to the positive electrode tab 3220.

A first insulating element 3610 may be disposed inside the first cap plate 3410, and the first insulating element 3610 may be positioned between the first cap plate 3410 and the electrode assembly 3200.

An electrolyte injection: port for electrolyte injection may be formed in the first cap plate 3410, and a sealing plug 3412 may be installed in the electrolyte injection port. The first insulating element 3610 may include an injection guide 3700, and the injection guide 3700 may be configured in the same structure as the injection guide according to any one of the first through seventh aspects described above.

In addition, the second cap assembly 3500 may include a second cap plate 3510 coupled to the casing 3100, a second terminal 3520 installed on the second cap plate 3510, and a second current collecting element 3570 fixed to the second terminal 3520 and coupled to the negative electrode tab 3230. The second terminal 3520 may be formed in a plate shape, and protrudes outward from the second cap plate 3510. A gasket 3525 for insulation may be installed between the second terminal 3520 and the second cap plate 3510. The second current collecting element 3570 may be inserted into the second terminal 3520 and coupled, by welding, to the negative electrode tab 3230. A second insulating element 3620 may be disposed inside the second cap plate 3510, and the second insulating element 3620 may be positioned between the second cap plate 3510 and the electrode assembly 3200.

A secondary battery according to an eleventh embodiment of the present disclosure will be described below.

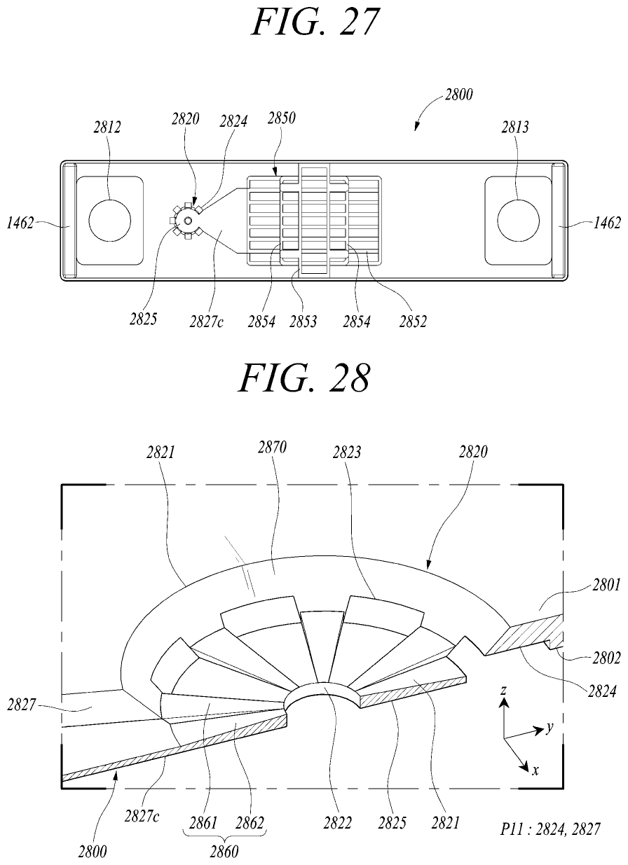

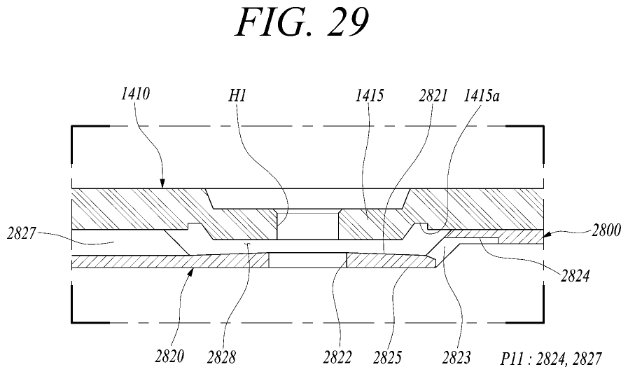

FIG. 26 is a perspective view illustrating an insulating element of the secondary battery according to the eleventh embodiment of the present disclosure, when viewed from above. FIG. 27 is a bottom view illustrating an insulating element of the secondary battery according to the eleventh embodiment of the present disclosure. FIG. 28 is a cutaway perspective view illustrating an injection guide of the insulating element according to the eleventh embodiment of the present disclosure. FIG. 29 is a partial cross-sectional view illustrating a cap plate and the insulating element according to the eleventh embodiment of the present disclosure.

Referring to FIG. 26 to FIG. 29, a secondary battery 3000 according to the eleventh embodiment has the same or similar structure as the secondary battery according to the first embodiment described above except for an insulating element 2800. Accordingly, a redundant description of the same component will be omitted.

An injection guide 2820 may be formed on an insulating element 2800, and the injection guide 2820 may include a concave portion 2821, an internal hole 2822, a side hole 2823, and an extension flow space P11.

The insulating element 2800 may be formed with a first hole 2812 into which a first terminal 1420 is inserted, a second hole 2813 into which a second terminal 1430 is inserted, and grooves 2814 and 2815 into which lower parts of gaskets 1425 and 1435 are inserted.

The concave portion 2821 may be positioned in a lower space corresponding to the electrolyte injection port H1 and is configured in a structure concavely recessed toward the electrode assembly 1200. A guide protrusion portion 2825 configured to protrude convexly inward may be formed on an opposite side of the concave portion 2821.

Meanwhile, a lower protrusion 1415 inserted into the concave portion 2821 may be formed at a lower portion of the cap plate 1410, and the lower protrusion 1415 may be formed in a truncated cone shape having an outer diameter gradually decreasing toward its lower portion.

An accommodation space 2828 configured to accommodate an electrolyte may be formed between the lower protrusion 1415 and the bottom plate 2860 of the concave portion 2821.

A groove 1415a, extending in a peripheral direction of the lower protrusion 1415 and surrounding the lower protrusion 1415, may be formed on a surface of the cap plate 1410 that faces the electrode assembly 1200.

The groove 1415a may be recessed from a lower surface of the cap plate 1410 and may be connected to an outer surface of the lower protrusion 1415.

The concave portion 2821 may include a bottom plate 2860 positioned at a lower portion and a side surface 2870 configured to connect the bottom plate 2860 to an outer surface 2801 of the base plate of the insulating element 1460, and the side surface 2870 may be disposed to be inclined with respect to an inner surface 1461a of the base plate of the insulating element 2800.

The bottom plate 2860 includes a plurality of first portions 2861 parallel to the outer surface 2801 of the insulating element 2800 and a plurality of second portions 2862 inclined with respect to the outer surface 2801 of the insulating element 2800, wherein the first portions 2861 and the second portions 2862 may be alternately arranged, and the second portions 2862 may be positioned between the first portions 2861.

A thickness of the second portion 2862 may gradually decrease toward a radial outer side of the concave portion 2821.

The internal hole 2822 may be positioned at a center of a bottom of the concave portion 2821 and may be formed to face the electrolyte injection port H1. A plurality of side holes 2823 may be formed in the side surface 2870 of the concave portion 2821.

The plurality of side holes 2823 may be disposed to be spaced apart from each other at intervals in a peripheral direction of the side surface 2870.

The extension flow space P11 may include a first extension flow channel 2824 and a second extension flow channel 2827, and the first extension flow channel 2824 and the second extension flow channel 2827 may be formed on surfaces facing opposite directions from each other.

The first extension flow channel 2824 and the second extension flow channel 2827 may be formed as a single path or a plurality of paths.

The first extension flow channel 2824 may be formed on an inner surface 2802 of the base plate of the insulating element 2800 that faces the electrode assembly 1200, and the second extension flow channel 2827 may be formed on an outer surface 2801 of the base plate of the insulating element 2800 that faces the electrode assembly 1200.

If the first extension flow channel 2824 and the second extension flow channel 2827 are formed on surfaces facing opposite directions, even if one surface is blocked, an electrolyte may easily move through the other surface.

The first extension flow channels 2824 may be connected to the side holes 2823 but may be formed in a groove shape recessed from the second surface 2802.

A plurality of the first extension flow channels 2824 may be disposed to be spaced apart in a peripheral direction of the concave portion 2821 on the inner surface 2802. The first extension flow channel 2824 may be connected to the second portion 2862.

The second extension flow channel 2827 may be connected to an exhaust portion 2850. The exhaust portion 2850 may be spaced apart from the concave portion 2821 in a longitudinal direction of the insulating element 2800.

The second extension flow channel 2827 may be formed in a groove shape recessed from the outer surface 2801 that faces the cap plate 1410.

The second extension flow channel 2827 may be connected to the second portion 2862.

The second extension flow channel 2827 may include a first extension portion 2827a having a width that increases as a distance from the concave portion 2821 increases, and a second extension portion 2827b having a uniform width and connecting the first extension portion 2827a and the exhaust portion 2850.

A flow path protrusion 2827c may be formed below the second extension flow channel 2827 on the second surface 2802. The flow path protrusion 2827c may be connected to the guide protrusion portion 2825.

The second extension flow channel 2827 may extend from the concave portion 2821 toward the exhaust portion 2850 to connect the concave portion 2821 and the exhaust portion 2850. The second extension flow channel 2827 may be connected to a discharge opening 2851.

The exhaust portion 2850 may be positioned below a vent hole H2 of cap plate 1400 and have the discharge opening 2851. The exhaust portion 2850 may assist with gas discharge.

The exhaust portion 2850 may include a plurality of divided bars 2852 extending in the longitudinal direction of the insulating element 2800. The discharge opening 2851 may be divided into a plurality of openings by divided bars 2852.

The exhaust portion 2850 may include a first frame 2853 and two second frames 2854 disposed next to the first frame 2853.

The first frame 2853 and the second frames 2854 may extend in a width direction of the insulating element 2800.

The first frame 2853 and the second frames 2854 may protrude toward the electrode assembly 1200, and the first frame 2853 may protrude further than the second frames 2854.

The first frame 2853 may be disposed at a center of the exhaust portion 2850 with respect to the longitudinal direction of the insulating element 2800.

The first frame 2853 and the second frames 2854 may improve strength of the insulating element 2800 and prevent deformation of the insulating element 2800.

When an electrolyte is injected into the concave portion 2821, a portion of the electrolyte moves through the internal hole 2822, a portion of the electrolyte moves through the first extension flow channel 2824, and a portion of the electrolyte may move through the second extension flow channel 2827 and the exhaust portion 2850.

Accordingly, even when a portion is blocked, the electrolyte may rapidly move to the electrode assembly 1200. In particular, since the second extension flow channel 2827 is formed on the first surface 2801, which is an upper surface of the base plate of the insulating element 2800, the electrolyte may easily move to the discharge opening 2851 through the second extension flow channel 2827 even when the second surface is blocked by a lower structure.

With a secondary battery according to an aspect of the present disclosure, an injection guide may be formed on an insulating element disposed below a cap plate, and the injection guide may include a concave portion and a side hole. Accordingly, even if a lower portion of an electrolyte injection port is blocked, an electrolyte may be easily injected through various paths.

In addition, an extension flow channel, which is connected to the side hole, may be formed on an outer side of the side hole. Accordingly, the electrolyte may be injected more rapidly and easily.

In addition, a lower protrusion, which is inserted into the concave portion, may be formed on the cap plate; an accommodation space is formed between the lower protrusion and a bottom plate of the concave portion; and the accommodation space and the extension flow channel are connected. Accordingly, even if a portion of flow paths is blocked, the electrolyte may be rapidly injected through another portion of the flow paths.

Although an aspect of the present disclosure has been described above, those skilled in the art may make various modifications and changes to the present disclosure by addition, modification, substitution, deletion, or supplementation of components, without departing from the spirit of the present disclosure set forth in the claims. Such modifications and changes should also be understood to fall within the scope of rights of the present disclosure.

What is claimed is:

1. A secondary battery comprising:
an electrode assembly;
a casing accommodating the electrode assembly;
a cap plate coupled to the casing and comprising an electrolyte injection port; and
an insulating element disposed between the cap plate and the electrode assembly,
wherein the insulating element includes:
a base plate, and
an injection guide facing the electrolyte injection port, and
the injection guide includes a concave portion recessed in the insulating element and surrounded by the base plate and configured to accommodate an electrolyte, wherein the concave portion includes a bottom plate, a side surface configured to connect the bottom plate to the base plate, and at least one side hole passing through the side surface; and
an extension flow channel connected to the concave portion via the at least one side hole and configured to extend outward from the concave portion and define a space, wherein the space is configured to receive electrolyte during an electrolyte injection,
wherein the extension flow channel extends along the base plate and is recessed into an inner surface of the base plate in a thickness direction of the base plate without extending through an outer surface of the base plate, the inner surface of the base plate facing the electrode assembly and the outer surface of the base plate facing toward the cap plate.

2. The secondary battery of claim 1, wherein the at least one side hole comprises a first portion configured to pass through the side surface in a thickness direction of the side surface and a second portion recessed in a thickness direction of the base plate.

3. The secondary battery of claim 1, wherein an internal cross-sectional area of the concave portion gradually decreases toward the electrode assembly.

4. The secondary battery of claim 1, wherein:
the side surface is inclined with respect to a lower surface of the cap plate, and
an inclination angle between a portion of the side surface that is oriented toward an inner side of the concave portion and a portion of the lower surface of the cap plate that faces the concave portion is from 25 to 75 degrees.

5. The secondary battery of claim 1, wherein a greatest width of the side surface is 1.25 to 5 times a thickness of a portion of the insulating element that is connected to a longitudinal outer side of the extension flow channel.

6. The secondary battery of claim 1, wherein a greatest width of the side surface is 1.02 mm to 3.5 mm.

7. The secondary battery of claim 1, wherein the bottom plate includes:
a first bottom surface parallel to a lower surface of the cap plate; and
a second bottom surface positioned radially outward of the first bottom surface and inclined downward with respect to the lower surface of the cap plate.

8. The secondary battery of claim 1, wherein the bottom plate includes a portion having a thickness gradually decreasing toward a radial outer side or a portion having a uniform thickness toward a radial outer side.

9. The secondary battery of claim 1, wherein a lower protrusion disposed on the cap plate is received within the concave portion, and an accommodation space is defined between the bottom plate and the lower protrusion, wherein the accommodation space is configured to receive electrolyte during the electrolyte injection.

10. The secondary battery of claim 9, wherein a smallest height of the accommodation space is from 0.25 to 4 times a thickness of the lower protrusion.

11. The secondary battery of claim 9, wherein a height of the accommodation space is uniform, or gradually increases in a radially outward direction.

12. The secondary battery of claim 9, wherein a distribution space in an annular shape is defined between the lower protrusion and the concave portion, extends higher than the accommodation space, and connects the accommodation space and the side hole.

13. The secondary battery of claim 1, wherein the injection guide further includes an internal hole in the bottom plate.

14. The secondary battery of claim 13, wherein a bottom space between an outer end of the internal hole and an outer end of the bottom plate is greater than a diameter of the internal hole.

15. The secondary battery of claim 13, wherein a bottom space between an outer end of the internal hole and an outer end of the bottom plate is from 1.05 to 1.8 times a diameter of the internal hole.

16. The secondary battery of claim 15, wherein the bottom space is from 3.5 mm to 12.5 mm.

17. The secondary battery of claim 1, wherein a bottom channel, connected to the side hole and recessed inward from a side end of the bottom plate, is located in the concave portion.

18. The secondary battery of claim 1, wherein the extension flow channel includes a groove recessed from the inner surface of the base plate that faces the electrode assembly.

19. The secondary battery of claim 18, wherein the extension flow channels is one among a plurality of extension flow channels provided on the base plate, wherein plurality of the extension flow channels extend radially from a center of the concave portion.

20. The secondary battery of claim 18, wherein a length of the extension flow channel is from 0.15 to 0.6 times a smallest diameter of the concave portion.

21. The secondary battery of claim 18, wherein:
the injection guide further comprises an internal hole in the bottom plate, and
a length of the extension flow channel is 0.4 to 1.5 times a diameter of the internal hole.

22. The secondary battery of claim 18, wherein a length of the extension flow channel in a direction extending outward from the concave portion is from 0.7 to 1.6 times a width of the extension flow channel in a direction perpendicular to the direction extending outward from the concave portion.

23. The secondary battery of claim 18, wherein the length of the extension flow channel is from 1.5 mm to 6 mm, and a width of the extension flow channel is 2.5 mm to 6.5 mm.

24. The secondary battery of claim 18, wherein a depth of the extension flow channel is from 0.15 to 0.5 times a thickness of a portion of the base plate that is connected to a longitudinal outer side of the extension flow channel.

25. The secondary battery of claim 18, wherein a depth of the extension flow channel is from 0.02 to 0.35 times a length of the extension flow channel.

26. The secondary battery of claim 18, wherein a depth of the extension flow channel is 0.1 mm to 0.5 mm.

27. The secondary battery of claim 1, wherein a smallest diameter of the concave portion is from 1.5 to 6.5 times a diameter of the electrolyte injection port.

28. The secondary battery of claim 27, wherein a smallest diameter of the concave portion is from 7 mm to 16.5 mm.

29. The secondary battery of claim 1, wherein a greatest depth of the concave portion is from 0.4 to 2.1 times a thickness of a portion of the base plate that is connected to a longitudinal outer side of the extension flow channel.

30. The secondary battery of claim 29, wherein a greatest depth of the concave portion is from 0.5 mm to 2.4 mm.
